(19) United States
(12) Patent Application Publication
(10) Pub. No.: US 2025/0168763 A1
(43) Pub. Date: May 22, 2025

(54) METHODS FOR ENERGY SAVING IN A CELLULAR NETWORK

(71) Applicants: CENTRE OF EXCELLENCE IN WIRELESS TECHNOLOGY, Chennai Tamil Nadu (IN); INDIAN INSTITUTE OF TECHNOLOGY MADRAS (IIT MADRAS), Chennai Tamil Nadu (IN)

(72) Inventors: Deepak AGARWAL, Chennai Tamil Nadu (IN); Deepak Padmanabhan MAYA, Chennai Tamil Nadu (IN); Priyanka DEY, Chennai Tamil Nadu (IN); Dhivagar BASKARAN, Chennai Tamil Nadu (IN); Jeniston Deviraj Klutto MILLETH, Chennai Tamil Nadu (IN); Bhaskar RAMAMURTHI, Chennai, Tamil Nadu (IN)

(21) Appl. No.: 18/839,053

(22) PCT Filed: Feb. 14, 2023
(86) PCT No.: PCT/IN2023/050149

§ 371 Date: Aug. 16, 2024

(30) Foreign Application Priority Data
Feb. 16, 2022 (IN) 202241008257

(51) Int. Cl. H04W 52/02; H04B 7/06; H04W 48/08; H04W 56/00

(52) U.S. Cl. CPC H04W 52/0203; H04B 7/0626; H04W 48/08; H04W 56/0015

(57) ABSTRACT

The present invention relates to method of energy saving in a cellular network. The method comprises configuring, by the Base Station (BS), different periodicity for at least one Synchronization Signal Block (SSB) beam of a plurality of SSB beams in an SSB burst, based on the load on the network. The method includes transmitting, by the BS, a relaxed signal in less number of time and frequency resources than the resources used for an SSB. The method further includes indicating sleep states of the BS to a User Equipment (UE) to reduce unwanted monitoring of resources. The method also includes determining, by the BS, active number of ports and indicating, to the UE, active ports using a parameter. The method further includes dynamically determining, by the BS, transmit power of downlink (DL) signal and DL channel, and signalling a parameter about the transmit power to the UE.

### FIELD OF THE INVENTION

The present invention relates to cellular wireless communication systems, and more particularly to adaptation of transmission and reception of signals and channels for energy saving in a cellular network.

### BACKGROUND OF THE INVENTION

Development in mobile communication technology has revolutionized human life. However, the huge power consumption and its implication on the environment is a serious issue that needs to be addressed. The power consumption also increases the total operational cost by a significant amount. In a radio network, a Base Station (BS) is one of the most power consuming units. The power consumption at the BS can be divided into two parts, namely static and dynamic. A BS performs some basic functions without considering the network load, user traffic and applicable scenarios. For an example, the BS transmits Synchronization Signal Block (SSB) at periodic intervals so that a User Equipment (UE) switching ON can initiate initial access procedure and neighbouring BS can initiate handover procedure for UEs. The power consumed by such basic functions is termed as static power consumption whereas the power consumed by the transmissions/reception at BS for serving the UEs is termed as dynamic power consumption.

Currently, BS performs the basic functionalities irrespective of the nature of deployment or the traffic load, leading to unnecessary transmissions and energy consumption. For example, during night, the traffic might be very low and there might not be many UEs switching on for initial access, especially in rural areas. In such a scenario, periodic transmission of SSB from BS as a basic functionality is not used by the UEs, however, the transmission of SSB leads to unnecessary power consumption at the BS. Therefore, methods to adapt these basic functionalities based on various network parameter is essential for reducing energy consumption.

Further, a BS transmits SSB in a batch with one SSB per beam by forming the SSB burst. The SSB per beam may be utilised for changing direction of each SSB transmission. In current framework, i.e., fifth generation (5G) New Radio (NR), SSBs active in a burst and the periodicity of burst may be configured semi statically using Radio Resource Control (RRC) message. Since, periodicity is common for all SSBs active in the burst irrespective of the traffic variance between different sections of the coverage area, there is unnecessary transmission of SSB and energy consumption. For an example, frequent transmission of SSB may be needed for a sector having high UE arrival rate, such as in a shopping mall, whereas it is not needed for a sector with low UE arrival rate. In current framework, the periodicity of burst may correspond to the sector having highest UE arrival rate that leads to unnecessary transmission of SSB in sectors with low UE arrival rate.

The number of spatial elements used for communication between nodes depends on various parameters of the network. For example, when the traffic is small and the resource utilization is low, the transmission capacity is redundant and hence some of the antenna components can be turned off to save energy. This phenomenon is more noticeable for cell-centre UEs when the packet size is small. In current framework, there is no provision to adapt spatial elements based on network parameters, especially dynamic adaptation. Enabling adaptation of the spatial elements based on the network parameters provides energy saving. Thus, there is a need for implementing signalling exchanges across the nodes for adaptation in an efficient way and with minimum impact on existing mechanisms.

Measurement of parameters of the channel and reporting of the parameters from transmitter to receiver is essential for efficient communication. The Channel State Information Reference Signal (CSI-RS) is used in NR for measuring parameters associated with the channel and reporting. The UE can be configured with multiple CSI-RS resource sets where each resource set contains a number of CSI-RS resources. Each CSI-RS resource can correspond to different number of ports, which is related to the antenna components used at the transmitter. The CSI-RS configuration is provided semi-statically to the UEs, whereas the CSI-RS resource set to measure and report can be signalled to UE either semi-statically or dynamically. All the resources in the selected resource set is measured by the UE and reported to the BS. In case of adaptation of spatial elements at the BS the active number of ports used for transmission will change resulting in deactivation of the CSI-RS resources within the CSI-RS resource set. Measurement of all resources in the selected CSI-RS resource set irrespective of the active number of ports leads to unnecessary monitoring and energy consumption at the UE.

In a scenario, when the UE is semi-statically configured to measure CSI-RS resource set consisting of resources corresponding to maximum of 8 ports, if the BS switch off some of the antenna components to save energy consumption and transmitting with 4 ports, then there would not be a CSI-RS transmission in resources corresponding to the 8 ports. If the UE is not informed about the reduction in number of ports to 4, then the UE unnecessarily monitors for CSI-RS in resources corresponding to 8 ports, leading to unnecessary processing. Thus, crucial energy is wasted at the UE.

Further, in a low load scenario with low UE traffic in the cellular network, there will be time instances where a BS does not have anything to transmit or receive. In that case, the BS can dynamically switch off its components and the operations for a duration and activate sleep state to save energy. Signalling exchanges between various nodes in the network is essential for efficient implementation of sleep state and to minimize its impact on the existing processes. For instance, the components and operations to deactivate and duration of sleep state can be determined based on parameters of the network as well as assistance information from various nodes in the network. Further, the UE will be configured with some operations in slots, which may fall in the sleep state of the BS. In that case, the UE will unnecessarily perform the configured operation causing its wastage of power. The configuration can be for some signals like SSB, CSI-RS, Sounding Reference Signal (SRS), Physical Downlink Control Channel (PDCCH), configured grant and semi-persistent scheduling. For an example, the UE is semi-statically configured to receive periodic CSI-RS in slot n, in which the BS is in sleep, then the BS will not transmit CSI-RS in slot n, but the UE will unnecessarily monitor for CSI-RS. Therefore, mechanisms to avoid such conflicts should be defined.

Further, the energy consumption is related to transmit power of signals and channels. The transmit power of the signals and channels depends on the type of signal/channel, channel between transmitter and receiver, interference, etc. In NR, transmit power is adapted using different power offsets defined in the standards, which are either predefined or configured semi-statically. For example, the possible set of values for the power offset between CSI-RS and SSB is predefined in the standard and a value from the set is indicated to the UE semi-statically. However, the parameters determining the transmit power, e.g., channel condition, can vary dynamically. Therefore, methods to improve flexibility of determination and configuring of transmit power is essential for energy saving.

Thus, there is a need to reduce energy consumption in the cellular network based on various information of the BS and network such as deployment scenario, channel conditions, and load within the cellular network.

### OBJECTIVES OF THE INVENTION

An objective of the present invention is to provide an efficient method of energy reduction in a cellular network to provide reduction in operational cost and to have a sustainable environment.

Another objective of the present invention is to adapt transmission of Synchronization Signal Block (SSB) for energy saving.

Another objective of the present invention is to optimise transmission and reception of signals and channels based on network conditions, to reduce energy consumption.

Another objective of the present invention is to adapt operations and components used for transmission or reception of various signals, for energy saving.

Another objective of the present invention is to provide methods to adapt elements in spatial domain for transmission or reception of various signals, based on network conditions to reduce the power consumption.

Another objective of the present invention is to provide methods to adapt transmit power of BS for various signals/channels based on network condition to reduce the power consumption.

Yet another objective of the present invention is to provide methods to reduce power consumption at the UE by avoiding unnecessary transmission, reception, or monitoring at the UE.

Still another objective of the present invention is provide methods and signalling exchanges to reduce/avoid the impact of adaptations on the performance of the system.

### SUMMARY OF THE INVENTION

The present invention discloses methods for energy saving in a cellular network.

In one method, adaptation of signals and channels in a cellular network may be performed. The method may comprise determining at least one information related to one or more of at least one first node and a network. The at least one first node may adapt the transmission pattern of at least one Synchronization Signal Block (SSB). The at least one first node may signal at least one parameter related to the adaptation to at least one second node.

In one aspect, the at least one first node may comprise one or more of at least one Base Station (BS), at least one Integrated Access and Backhaul (IAB) node, at least one relay and at least one Distributed Unit (DU).

In one aspect, the at least one second node may comprise one or more of at least one User Equipment (UE), at least one IAB node, at least one DU, at least one Mobile Termination (MT) unit, at least one relay and at least one BS.

In one aspect, the at least one information may comprise at least one of load, traffic conditions, channel conditions, number of second nodes connected to the at least one first node, the buffer status of the at least one second node, types of the at least one second node, deployment scenarios and UE arrival rate.

In one aspect, the signalling may be performed using at least one of Radio Resource Control (RRC) message, Medium Access Control Element (MAC-CE), control channel, broadcast channel, sidelink channel, and Xn interface.

In one aspect, adapting the transmission pattern may comprise varying the periodicity of one of at least one SSB beam from a plurality of SSB beams of an SSB burst, at least one SSB group of an SSB burst, and at least one SSB beam of at least one SSB group of an SSB burst.

In one aspect, the SSB beams may have same SSB order in plurality of groups are assigned with same periodicity.

In one aspect, the parameter may comprise one or more of at least one periodicity, at least one index value, and a granularity of varying the periodicity. The granularity may comprise one of beams and SSB groups in the SSB burst.

In one aspect, the index value may comprise at least one of beam index and group index.

In one aspect, an indication for reusing the at least one periodicity across the SSB groups may be given.

In one aspect, the at least one parameter may be represented using ceil {M Log₂(N)} bits. M may denote at least one of maximum number of group and number of beams and N may denote total number of options for periodicity.

In one method, for adaptation of signals and channels in a cellular network, one or more information related to one or more of at least one first node and a network may be determined. The at least one first node may transmit a relaxed signal in at least one first cell. The relaxed signal may be transmitted in less number of at least one of time and frequency resources than the resources used for an SSB.

In one aspect, the at least one first node may comprise one or more of at least one Base Station (BS), at least one Integrated Access and Backhaul (IAB) node, at least one relay and at least one Distributed Unit (DU).

In one aspect, the at least one information may be at least one of load condition, traffic conditions, channel conditions, number of at least one second nodes connected to the at least one first node, the buffer status of the at least one second node, types of the at least one second node, deployment scenarios, and UE arrival rate.

In one aspect, the relaxed signal may comprise at least one of Primary Synchronization Signal (PSS), Secondary Synchronization Signal (SSS), a first portion of Physical Broadcast Channel (PBCH), a threshold value, and scheduling for a trigger signal.

In one aspect, the first portion of PBCH may comprise at least one parameter related to at least one of time domain characteristics and beam specific characteristics of the relaxed signal.

In one aspect, the first portion of PBCH may comprise at least one of system frame number, cell barring indication, and SSB index.

In one aspect, the second portion of PBCH may be one of predefined in the standards, broadcasted by at least one first node, transmitted to the at least one second node by at least one third node, and transmitted to the at least one second node through at least one second cell.

In one aspect, the at least one second node may comprise one or more of at least one User Equipment (UE), at least one IAB node, at least one Mobile Termination (MT) unit, at least one relay, and at least one BS.

In one aspect, the at least one third node may comprise one or more of IAB node, at least one Distributed Unit (DU), at least one Mobile Termination (MT) unit, at least one relay, and at least one BS.

In one aspect, the at least one UE may be one of a connected UE, a non-connected UE, an inactive UE, and a new UE searching for a new BS.

In one aspect, the second portion of PBCH may comprise parameters related to at least one of frequency domain characteristics of relaxed signal, time domain characteristics of relaxed signal, scheduling of Demodulation Reference Signal (DMRS), scheduling for control channel, broadcast channel specific characteristic, beam specific characteristics, availability of the cell, and any other cell specific parameters.

In one aspect, the second portion of PBCH may comprise at least one of sub carrier spacing, DMRS position, subcarrier offset between SSB and common resource block, cell barring indication, intra frequency reselection, configuration for control resource set zero, configuration for search space zero, any spare bits, type of broadcast channel, indication for half frame with SSB.

In one aspect, the at least one first node may share the second portion of PBCH to the at least one third node.

In one aspect, the second portion of PBCH may be transmitted through at least one of control channel, broadcast channel, Medium Access Control Element (MAC-CE), and Resource Control (RRC) message.

In one aspect, the transmissions of at least one of SSB, data channel, control channel, and Reference Signal (RS) may be skipped.

In one aspect, the method may comprise receiving by the at least one second node the relaxed signal, determining by the at least one second node at least one parameter related to at least one first cell using relaxed signal, and transmission of a trigger signal by the at least one second node.

In one aspect, the at least one parameter may comprise at least one of a signal quality, an identity of the at least one first cell, and an information to perform at least one of UL synchronization and transmit RACH.

In one aspect, the signal quality may comprise at least one of Reference Signal Received Power (RSRP), Reference Signal Strength Indicator (RSSI), Reference Signal Received Quality (RSRQ), and Signal to Noise plus Interference Ratio (SINR).

In one aspect, the trigger signal may comprise at least one of a measurement report, Random Access Channel (RACH) signal, a low complexity wake up signal, an indication, a predefined sequence, an RS, and the identity of the at least one first cell.

In another aspect, the method may comprise transmission of trigger signal may be through broadcasting or transmitting to the at least one first node.

In one aspect, a resource for transmitting the trigger signal may be one of predefined in standards, obtained from the relaxed signal, configured by at least one first node, or preconfigured by at least one third node.

In one aspect, configuring by at least one first node may be through the at least one second cell.

In one aspect, the transmission of trigger signal to at least one first node may be through one of at least one third node, the network, the first cell, and the at least one second cell.

In one aspect, the transmission of the trigger signal may be performed when the parameter is above a threshold. The threshold may be one of predefined in standards, determined by the at least one second node, configured to at least one second node, and transmitted within relaxed signal.

In one aspect, the at least one second node may be configured with the threshold by one of at least one first node, at least one third node and at least one second cell.

In one aspect, the threshold may be determined based on noise floor.

In one aspect, the at least one first node may receive a trigger signal from one or more of at least one second node, the network and at least one third node, wherein the trigger signal is at least one of a measurement report, a RACH signal, a low complexity wake up signal, a RS, the identity of the at least one first cell, and a one bit indication.

In one aspect, the complete functionality of the first cell may be activated by the at least one first node.

In one aspect, the reception of trigger signal may be done by one of a low complex wake-up receiver of the at least one first node, monitoring a set of resources by the at least one first node, and a dedicated sensor at the at least one first node.

In one aspect, transmission of one of the second portion of PBCH, the full PBCH associated with the relaxed signal, command to use the predefined values of the second portion of PBCH, and an SSB may be performed by the at least one first node.

In one aspect, the transmission may occur through at least one of the first cell, at least one second cell, broadcasting, and the at least one third node.

In one aspect, the relaxed signal may comprise at least one of multiplexed PBCH information of fourth symbol and at least one of the second symbol and third symbol of an SSB, and reduced length PSS sequence in the SSB.

In one aspect, the relaxed signal may be meant for power control.

In one aspect, the at least one the first cell and the at least one second cell may be a carrier.

In another method, to perform energy saving in a cellular network, at least one information related to one or more of at least one first node and a network may be determined. The at least one first node may determine at least one spatial element from the plurality of spatial elements, needed for communicating with at least one second node based on the at least one information. The at least one first node may determine at least one parameter related to the at least one spatial element. The at least one first node may indicate to the at least one second node, the at least one parameter related to the at least one spatial element. The at least one first node may determine at least one of transmission and reception using the at least one spatial element.

In one aspect, the at least one first node may comprise one or more of at least one base station (BS), at least one integrated access and backhaul (IAB) node, at least one relay and at least one distributed unit (DU).

In one aspect, the at least one second node may comprise one or more of at least one user equipment (UE), at least one IAB node, at least one distributed unit (DU), at least one mobile termination (MT) unit, at least one relay and at least one BS.

In one aspect, the at least one information may comprise one or more of load, traffic conditions in the network, channel conditions between the at least one first node and the at least one second node, number of second nodes connected to the at least one first node, location of the at least one second node, deployment scenario, UE arrival rate, and types of the at least one UE.

In one aspect, the at least one parameter may be indicated to the at least one second node using at least one of Downlink Control Information (DCI), Medium Access Control Element (MAC-CE), broadcast channel, and Radio Resource Control (RRC) message.

In one aspect, the at least one spatial element from the plurality of spatial elements may include active number of ports in the network.

In one aspect, the active number of ports may be one of a difference between total number of ports and number of ports to be deactivated by the at least one first node, a difference between total number of ports and number of ports deactivated by the at least one first node, dependent based on the spatial elements to be deactivated, and dependent based on the deactivated spatial elements.

In one aspect, the performing at least one of transmission and reception using the at least one spatial element may comprise one of deactivation of at least one spatial element from a plurality of spatial elements based on the at least one information, and deactivation of at least one port from a plurality of ports based on the number of spatial elements.

In one aspect, determining the at least one spatial element from the plurality of spatial elements may comprise performing by the at least one first node at least one of deactivation of the at least one spatial element from a plurality of spatial elements based on the at least one information, or deactivation of at least one port from a plurality of ports based on the number of spatial elements.

In one aspect, the at least one parameter may comprise at least one of active number of ports, indices of active number of ports, maximum number of ports active at a time, index of maximum number of ports, and variation in number of ports.

In one aspect, the at least one second node may receive the at least one parameter from the at least one first node, and determine the active number of ports.

In one aspect, the at least one second node may determine at least one Channel State Information-Reference Signal (CSI-RS) resource corresponding to the active number of ports, monitor the at least one CSI-RS resource, and measure the at least one CSI-RS resource.

In one aspect, the active number of ports may be less than the maximum number of ports active at a time.

In one aspect, the at least one parameter may be represented using ceil {Log₂(M)} bits, where M may denote total number of options for the number of ports.

In one aspect, a time offset between the time resource of reception of the at least one parameter and a time resource of at least one of transmission and the reception may be indicated along with the at least one parameter.

In one aspect, the time offset between indicating the at least one parameter and performing the at least one of transmission and reception may be predefined in the standards.

In one aspect, the at least one parameter may be valid until one of expiry of a time period indicated along with the at least one parameter, a new indication about the at least one parameter is received from the at least one first node, or a deactivation command is received from the at least one first node.

In one aspect, the at least one parameter may include at least one CSI-RS resource from plurality of CSI-RS resources. The at least one CSI-RS resource may be transmitted by the at least one first node using the number of spatial elements.

In one aspect, the at least one CSI-RS resource may be indicated using CSI-RS resource index.

In one aspect, the at least one parameter may be indicated using a bitmap.

In one aspect, the bitmap may indicate one of the at least one active port from the plurality of ports, and at least one active CSI-RS resource from the plurality of CSI-RS resources.

In one aspect, the active CSI-RS resource may correspond to the active number of ports.

In one aspect, at least one bit of the bitmap may be set when one of a port of the plurality of ports and a CSI-RS resource of the plurality of CSI-RS resources may be active.

In one aspect, at least one bit of the bitmap may be reset when one of a port of the plurality of ports and a CSI-RS resource of the plurality of CSI-RS resources may be inactive.

In another method, to perform power saving, at least one first node may dynamically determine a transmit power of one or more of at least one Downlink (DL) signal and at least one DL channel. The at least one first node may signal at least one parameter related to the transmit power to at least one second node. The at least one first node may perform transmission of one or more of at least one DL signal and at least one DL channel with the transmit power.

In one aspect, the transmit power may be determined based on at least one of interference strength, location of at least one second node, deployment scenario, types of the at least one user equipment (UE) and channel condition between the at least one first node and at least one second node.

In one aspect, the at least one parameter may be at least one of a multiplication factor, a power offset, and a type of power offset.

In one aspect, the multiplication factor may be applied to the power offset. The power offset may be determined by the type of power offset.

In one aspect, the type of power offset may comprise one of a ratio of power per Resource Element (RE) between Channel State Information-Reference Signal (CSI-RS) and Physical Downlink Shared Channel (PDSCH), a ratio of power per RE between CSI-RS and Synchronization Signal Block (SSB), and a ratio of power per RE between Demodulation Reference Signal (DM-RS) and PDSCH.

In one aspect, the at least one parameter may be the value of the power offset.

In one aspect, the power offset may be a ratio of power per RE between one or more of the at least one downlink signal and at least one DL channel.

In one aspect, a value of the multiplication factor may be determined based on a variation in the transmit power of one or more of at least one DL signal and at least one DL channel.

In one aspect, the value of the multiplication factor may be a value ranging from 0 to 1.

In one aspect, the signalling may be performed using at least one of control channel, broadcast channel, and Medium Access Control Element (MAC-CE)

In one aspect, the transmit power of one or more of at least one DL signal and at least one DL channel may be multiplied with the multiplication factor for accurate measurement of Downlink signals at the at least one second node.

In one aspect, the downlink signal may comprise one of Primary Synchronization Signal (PSS), Secondary Synchronization Signal (SSS), DMRS, SSB and CSI-RS.

In one aspect, the downlink channel may comprise one of Physical Broadcast Channel (PBCH), PDSCH and Physical Downlink Control Channel (PDCCH).

In one aspect, the at least one first node may comprise one or more of at least one base station (BS), at least one Integrated Access and Backhaul (IAB) node, at least one relay, and at least one Distributed Unit (DU).

In one aspect, the at least one second node may comprise one or more of at least one UE, at least one IAB node, the at least one DU, at least one Mobile Termination (MT) unit, at least one relay, and at least one BS.

In another method, to perform energy saving in a cellular network, at least one information related to one or more of at least one first node and a network may be determined. The at least one first node may determine based on the at least one information of one or more of at least one operation to be deactivated and at least one parameter related to the deactivation of the at least one operation. The at least one first node may signal to at least one second node, the at least one parameter related to the deactivation of the operation. The at least one first node may deactivate the at least one operation.

In one aspect, the at least one first node may comprise one or more of at least one base station (BS), at least one integrated access and backhaul (IAB) node, at least one relay and at least one distributed unit (DU).

In one aspect, the at least one second node may comprise one or more of at least one user equipment (UE), at least one IAB node, at least one distributed unit (DU), at least one mobile termination (MT) unit, at least one relay and at least one BS.

In one aspect, the at least one information may be at least one of channel conditions, UE arrival rate, deployment scenario, number of connected UEs, traffic and load on the at least one first node.

In one aspect, the at least one parameter may include one or more of the at least one operation, starting time of the deactivation, duration of the deactivation, type of deactivation, a priority rule, indication for re-assignment of time resource associated with deactivation, and beam ID (SSB index).

In one aspect, the at least one of the starting time of the deactivation, duration of the deactivation, and indication for re-assignment of time resource associated with deactivation is indicated in terms of multiple of at least one of symbols, slots, sub-frames and frames.

In one aspect, the multiple of at least one of the symbols, slots, sub-frames and frames may be indicated as at least one of a time index and a number.

In one aspect, at least one of the start time of the deactivation and the duration of the deactivation is one of a dynamic value, one or more preconfigured value, and a value chosen from a set of predefined values.

In one aspect, the type of deactivation is predefined.

In one aspect, the type of deactivation may comprise at least one of duration of deactivation, one or more of at least one operation, signals and components deactivated, and the priority rule.

In one aspect, the signals may comprise at least one of SSB, RACH, control channel, data channel, and RS.

In one aspect, the indication for re-assignment may be meant for informing to at least one second node to re-assign the time resource and performing the at least one operation based on the reassigned time resource.

In one aspect, the priority rule may comprise performing one or more of transmission and reception of at least one signal in a resource overlapping with duration of deactivation.

In one aspect, the at least one signal may comprise one or more of PSS, SSS and PBCH.

In one aspect, the at least one first node may reschedules the at least one operation in a first available active time resource after the duration of the deactivation.

In one aspect, the signalling may comprise re-assigning by the at least one first node one or more time resource associated with the deactivation.

In one aspect, the at least one first node may perform the one or more operation based on the reassigned time resource.

In one aspect, the at least one operation may comprise at least one of transmission of one or more of SSB, control channel, data channel, and RS, and reception of one or more of RACH, control channel, data channel and RS.

In one aspect, one or more of signalling and deactivation may be at either semi-static or dynamic.

In one aspect, the signalling may be performed using at least one of Downlink Control Information (DCI), broadcast channel, Medium Access Control Element (MAC-CE), and Radio Resource Control (RRC) message.

In one aspect, the deactivation may be performed for one or more of at least one cell, at least one beam, at least one carrier and at least one sector.

In one aspect, the at least one second node may receive the at least one parameter related to deactivation, and perform the at least one operation based on the at least one parameter related to deactivation of the at least one operation. The at least one operation may comprise one or more of skipping the at least one operation, and re-assigning the time resource for performing the at least one operation based on the reassigned time resource.

In one aspect, the at least one first node may reactivate at least one operation upon reception of a trigger signal.

In one aspect, the trigger signal may be either broadcasted or transmitted to the at least one first node.

In one aspect, the at least one first node may receive the trigger signal from one or more of at least one third node and the network.

In one aspect, the at least one third node may comprise one or more of at least one UE, at least one active BS, at least one IAB node, at least one DU, and at least one relay.

In one aspect, the UE may be one of a connected UE, a non-connected UE, an inactive UE, and a new UE searching for a new BS.

In one aspect, the at least one first node may receive the trigger signal using a set of resources, may comprise the set of resources are one of predefined in standards and configured to the at least one third node, or using a dedicated receiver to receive the trigger signal.

In one aspect, the set of resources may comprise at least one of time resources, frequency resources, spatial resources, periodicity, and validity of the resources.

In one aspect, the spatial resources may comprise at least one of SSB index, beam index, beam pair index, Reference Signal Index (RS-ID).

In one aspect, the periodicity may comprise an ON cycle in which the at least one first node will switch ON for a predefined time duration at intervals to monitor the trigger signal.

In one aspect, the set of resources may be configured to the at least one third node by one of the at least one first node, the at least one second node or the network. The at least one first node may inform one of at least one second or network about the configured set of resources.

In one aspect, the at least one third node may transmit the trigger based on at least one of measurement of a signal transmitted by the at least one first node, signal quality of at least one UE connected to the third node, and assistance information from the at least one UE connected to the third node.

In one aspect, the assistance information may comprise one or more of signal quality, location and direction of movement of the at least one UE.

In one aspect, the at least one third node may comprise time synchronized with the at least one first node.

In one aspect, the one or more of the at least one third node, and the network may transmit the trigger to a plurality of first nodes.

In one aspect, the trigger signal may comprise one of a measurement report of a DL signal received from the first node, a signal representing presence of a new UE upon switching ON, an indication signal, a predefined sequence, and a Sounding Reference Signal (SRS).

In one aspect, the measurement report may comprise one of quality of the received DL signal, Identity (ID) of the received DL signal, sequence of the received DL signal, and a parameter received in the DL signal.

In one aspect, the at least one first node may deactivate the at least one operation when no communication is established with at least one node within a duration of time after the reception of the trigger.

In one aspect, the at least one second node may update the size of a Hybrid Automatic Repeat reQuest (HARQ) codebook based on the at least one parameter related to deactivation.

In one aspect, the updating may comprise determining whether the at least one operation comprises transmission of data signals by the at least one first node, determining at least one candidate slot corresponding to HARQ codebook overlapping with the duration of deactivation, and skipping feedback for at least one candidate slot in the HARQ codebook.

In one aspect, the at least one second node may comprise an Indication of Availability (IA) for at least one soft resource based on the at least one parameter related to deactivation.

In one aspect, the IA may comprise the at least one operation may comprise at least one of transmission and reception, determining the at least one soft resource overlapping with the duration of deactivation, and deriving IA for the at least one soft resource.

In one aspect, the signalling may comprise one of at least one of shifting a transmission of synchronization signal block (SSB) to the other half frame, updating a one bit parameter half frame bit in a Physical Broadcast Channel (PBCH), and informing the at least one second node about the shifting operation.

In one aspect, the transmission of SSB may be shifted to a first active time resource after the duration of the deactivation. The at least one second node may be informed about the shifting operation.

In one aspect, the transmission of SSB may be shifted to the other half frame when the duration of the deactivation of operations is less than half frame size.

In one aspect, the transmission of SSB overlap with duration of deactivation.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. In the drawings:

FIG. 1 illustrates a method for adaptation of signals and channels in a cellular network, in accordance with a first embodiment of the present invention;

FIG. 2 illustrates a method for adaptation of signals and channels in a cellular network for transmission of relaxed signal for performing basic functionalities at the BS, in accordance with the first embodiment of the present invention;

FIG. 3 illustrates a Base Station (BS) triggering another BS, in energy saving mode, based on assistance information from the connected UE, in accordance with the first embodiment of the present invention;

FIG. 4 illustrates a method for adapting the spatial elements used for transmission or reception at a BS and its indication to a UE, in accordance with second embodiment of the present invention;

FIG. 5 illustrates a method of adapting the transmit power of a signal/channel by a BS, in accordance with the second embodiment of the present invention;

FIG. 6 illustrates a method of activating sleep state by a BS, in accordance with third embodiment of the present invention; and

FIG. 7 illustrates an impact of sleep state at BS on semi-static HARQ code book, in accordance with the third embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present invention discloses method for energy saving in a network. The method includes adaptation of signals and channels in a cellular network. In one implementation, configuring different periodicity for different Synchronization Signal Block (SSB) beams or group of SSB beams in a burst based on channel condition and information of the network may be performed. In another implementation, transmitting a relaxed signal instead of a Synchronization Signal Block (SSB) based on channel condition and information of the network may be performed. In another implementation, a Base Station (BS) may activate sleep state to adapt at least one of the transmission and reception of signals/channels based on information of the BS and the network and the sleep states may be indicated to a User Equipment (UE) to reduce unwanted transmissions/monitoring at the UE. In another implementation, the BS may adapt the number of spatial elements used for transmission and reception of signals/channels based on the information of the network and may indicate information about the active ports to the UE using one of maximum number of active ports, Channel State Information-Reference Signal (CSI-RS) resources and a bitmap. In another implementation, the BS may adapt the transmission power of signals/channels based on the information of the network and may indicate information about the adapted transmit power to the UE using one of a multiplication factor corresponding to the change in transmit power, a value of power offset, and a type of power offset.

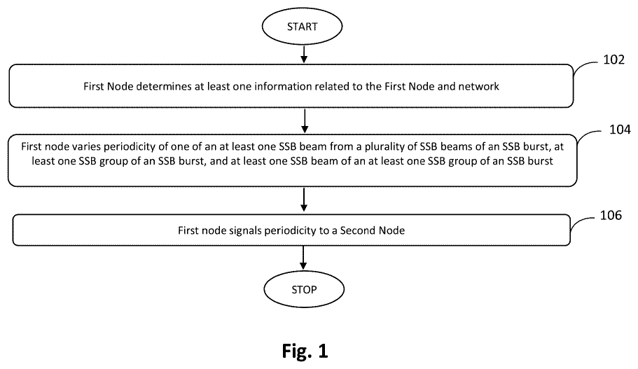

FIG. 1 illustrates a method of adaptation of signals and channels in a cellular network, in accordance with a first embodiment of the present invention. At step 102, the first node may determine at least one information related to one or more of at least one first node and a network. The network may comprise a core unit, a central entity, and at least one first node connected to at least one second node. The at least one first node may be one of at least one Base Station (BS), at least one Integrated Access and Backhaul (IAB) node, at least one relay, and at least one Distributed Unit (DU). The at least one second node may be one or more of at least one User Equipment (UE), at least one IAB node, at least one DU, at least one Mobile Termination (MT) unit, at least one relay, and at least one BS. The at least one information may comprise one or more of load, traffic conditions, channel conditions, number of second nodes connected to the at least one first node, the buffer status of the at least one second node, types of the at least one second node, deployment scenarios, and UE arrival rate. At step 104, the at least one first node may adapt transmission pattern of at least one SSB based on at least one information. Adapting the transmission pattern may comprise varying the periodicity of one of at least one SSB beam from a plurality of SSB beams of an SSB burst, at least one SSB group of an SSB burst, and at least one SSB beam of at least one SSB group of an SSB burst. At step 106, the at least one first node may signal at least one parameter related to the adaptation to at least one second node. The at least one parameter may be indicated to the UEs through one of a connected cell, a SL UE, broadcast and a neighbouring BS. The signal may be sent using at least one of Radio Resource Control (RRC) message, Medium Access Control Element (MAC-CE), control channel, broadcast channel, sidelink channel and Xn interface. The parameter may comprise one or more of at least one periodicity, at least one index value, and a granularity of varying the periodicity. The granularity may comprise one of beams and SSB groups in the SSB burst.

In one implementation, beam-based periodicity indicating different periodicities may be assigned for different SSB beams in a SSB burst. An additional field may be introduced in Radio Resource Control (RRC) message for indicating different periodicity for each SSB in the burst. In one scenario, N options may be considered for periodicity. Therefore, a total of ceil {Log₂(N)} bits is needed to select one periodicity. For an example, currently NR supports 6 options for SSB periodicity, which are {5, 10, 20, 40, 80, 160}, and it requires 3 bits to select one periodicity for a beam from the set. Therefore, the total number of bits required in the new field should be ceil {Log₂(N)} times the number of maximum beams in the burst. As another example, in frequency range 1 (FR1), SS burst having 8 beams require 24 bits to signal the periodicity per beam. The new field will have bits per active beams providing periodicity and unused/reserved bits for inactive beams.

In another implementation, group-based periodicity may be assigned. Group-based periodicity may indicate different periodicity among different SSB groups in the SSB burst. NR supports maximum 8 groups with an enabling parameter in RRC message for grouping of SSBs. A new parameter may be introduced for indicating various periodicities for different SSB groups in an SSB burst. In one scenario, N options may be considered for periodicity. Therefore, a total of ceil {Log₂(N)} bits may be required to indicate one periodicity value to a group. Therefore, the total number of bits in the new parameter is the product of maximum number of groups and number of bits required for representing one periodicity value. As another example, in frequency range 2 (FR2), SSB burst with 64 SSB beams grouped into 8 groups may require 24 bits (3 bits to indicate periodicity for a group and 8 groups).

In another implementation, a periodicity pattern may be defined for beams in an SSB group and the same pattern may be reused across SSB groups, such that SSB beams in different groups with same SSB order have same periodicity. A new parameter may be introduced to denote periodicity pattern (or periodicity of each beam in an SSB group) to the UE. The periodicity indicated by the new parameter may be interpreted as periodicity pattern for a SSB group and the same pattern may be repeated across SSB groups. In case of N options for periodicity, a total of ceil {Log₂(N)} bits are required to indicate one periodicity value to a beam in a group. The number of bits needed to indicate periodicity pattern is the product of number of beams in the group and ceil {Log₂(N)}.

In another implementation, an additional one-bit parameter may be indicated to the UE to select between group-based periodicity and reuse periodicity pattern across groups. The parameter introduced for indicating various periodicities may be interpreted differently based on the additional one-bit parameter. For an example, if there are 8 SSB groups with each group having 8 beams then, based on the above discussion, total number of bits needed for the new parameter in RRC message is 24 bits. If new parameter indicate periodicity as {5, 10, 40, 10, 10, 20, 20, 20} and the additional one-bit parameter is 0, then all beams in a first SSB group may have periodicity of 5 ms, a second SSB group may have periodicity of 10 ms, and so on. If new parameter indicate periodicity as {5, 10, 40, 10, 10, 20, 20, 20} and additional one-bit parameter is 1, then first SSB beam in all SSB groups may have periodicity of 5 ms, second SSB beam in all SSB groups may have periodicity of 10 ms, and so on. Total number of bits needed to indicate group based periodicity or periodicity pattern is lesser than the beam-based periodicity approach.

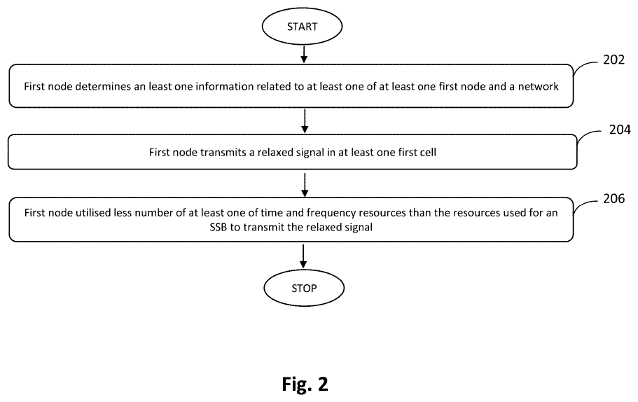

FIG. 2 illustrates a method of adaptation of signals and channels in a cellular network for transmission of relaxed signal for performing basic functionalities at the BS, in accordance with first embodiment of the present invention. At step 202, at least one information related to at least one first node and a network, may be determined. The at least one information may be at least one of load condition, traffic conditions, channel conditions, number of at least one second nodes connected to the at least one first node, the buffer status of the at least one second node, types of the at least one second node, deployment scenarios, and UE arrival rate. At step 204, a relaxed signal may be transmitted, by the at least one first node, in at least one first cell. At step 206, the relaxed signal may be occupying less number of at least one of time and frequency resources than the resources used for the SSB transmission. Further, the transmission of relaxed signal consumes less resources and energy compared to transmission of SSB. The at least one first node may comprise one or more of at least one BS, at least one Integrated Access and Backhaul (IAB) node, at least one relay, and at least one Distributed Unit (DU).

The first node may transmit only a relaxed signal that consumes less energy, to perform basic functionalities. The first node performs some basic functions even when it is not serving any UE. For instance, the first node may transmit SSB in each cell at periodic intervals, so that a UE switching ON can initiate initial access procedure and a neighbouring BS can initiate handover procedure for UEs. Transmission of signals and the procedures associated with the basic functionalities of the first node consume energy at the first node. The transmission of the relaxed signal may include skipping the transmissions of at least one of SSB, data channel, control channel, and reference signal (RS).

When the first node transmits only the relaxed signal, the first node may transmit, instead of full SSB, a signal consisting of one or more of a Primary Synchronization Signal (PSS), a Secondary Synchronization Signal (SSS), a portion of Physical Broadcast Channel (PBCH), a threshold value and scheduling information for a trigger signal. The BS, in one implementation, may broadcast only the PSS and the SSS at regular intervals. In another implementation, the first node may transmit the PSS, the SSS and a first portion of the PBCH as relaxed signal. The first portion of the PBCH may comprise at least one parameter related to at least one of time domain characteristics and beam specific characteristics of the relaxed signal. For an example, the first portion of PBCH may comprise at least one of system frame number, cell barring indication, and SSB index. A second portion of the PBCH may be one of predefined in standards, broadcasted by at least one first node, and transmitted through other BS or nodes or the cell to which the UE is connected.

The relaxed signal containing PSS and SSS may occupy only 2 symbols and 127 subcarriers in each symbol, compared to 4 symbols and 240 subcarriers per symbol in full SSB, thereby reducing the transmission time and energy.

The UE, receiving the relaxed signal, may identify cell Identifier (ID) corresponding to the relaxed signal using PSS and SSS and may measure parameters of the received signal. Further, the UE may transmit trigger signal based on the measured parameters. For example, the trigger signal may be transmitted if the measured parameter is above certain threshold. The trigger signal may be broadcasted or transmitted based on the scheduling information in the relaxed signal or in predefined resources. The trigger signal may comprise at least one of a measurement report, RACH signal, a low complexity wake up signal, an indication, a Reference Signal (RS), and the identity of the at least one cell in which relaxed SSB is transmitted.

For mobility measurement and performing hand over, a BS configures connected UE with cell Identifier (ID) to measure, periodicity to measure, quantity to measure, and resources to send measurement report. The connected UE may identify the cell ID corresponding to the received relaxed signal using PSS and SSS, may perform measurement using the relaxed signal and may transmit trigger signal to the BS based on the measured parameters. For example, trigger is transmitted if the measured parameter is above certain threshold. The trigger signal may be one of an one bit indication, a dedicated signal and the measured quantity. The trigger may be one of broadcasted and, transmitted based on the scheduling information in the relaxed signal or using the resources configured by the BS or in predefined resources. The BS may receive trigger signal and perform a set of operations depending on the scenario, and the type of trigger signal received. In one scenario, if the same BS has transmitted the relaxed signal and received the trigger, then the BS may initiate transmission of one of full SSB, PBCH, and a second portion of PBCH and may activate its full functioning. The BS may initiate transmission based on the trigger signal. For e.g., if trigger signal has strength above some threshold or measurement report obtained as trigger is above some threshold.

In another scenario, if the relaxed SSB is transmitted by one BS and the trigger is received by another BS, from the connected UE, then the BS receiving the trigger, may transmit a second trigger signal to the BS transmitting relaxed SSB. The BS may transmit a second trigger based on the trigger received from the UE. For e.g., if the measurement reports contained in the trigger are good enough to initiate hand-over or above some threshold. However, in case of self-organizing network and Wi-Fi, the BS, transmits a trigger to the sleeping BS, to transmit SSB, for initiating handover procedure. However, the hand over may happen only if the measurements on the SSB are good. Thus, in SON and WiFi, BS may wake up unnecessarily and no UE is handed over to it due to poor measurements. This leads to unnecessary waking up and transmission of full SSB burst by the sleeping BS.

In response to receiving second trigger, the BS, transmitting the relaxed SSB, may transmit one of the full SSB, PBCH, and the second portion of PBCH. The transmission can be broadcast or through the cell in which UE is connected. For e.g., BS2 is receiving measurement report from UE1 and is transmitting second trigger to BS1, then the BS1 can transmit/broadcast full SSB or PBCH or second portion of PBCH. In another option the BS1 can transmit full SSB or PBCH or second portion of PBCH to UE1 through the cell of BS2 to which UE1 is connected. In case of transmitting PBCH or second portion of PBCH through the cell in which UE is connected, then the UE may perform Downlink (DL) synchronization with the cell that transmits relaxed signal and may directly initiate Random Access Channel (RACH) procedure for Uplink (UL) synchronization based on the information given in the PBCH, thus saving time in handover.

In one implementation, the BS may transmit relaxed signal only for certain cells or carriers. In that case, the UE connected to one or more of other cells or carriers of the BS, may perform measurement of the cell using relaxed signal and report the measured quantity through the connected cell. Based on the measurement report, the BS may activate the cell and may transmit one of full SSB burst, PBCH and the second portion of the PBCH to the UE. The PBCH or the second portion of the PBCH may be transmitted using the activated cell or through the other cell or carrier to which the UE may be connected when frame boundaries are aligned across the cells or carriers of the BS to have same System Frame Number (SFN) across the cells.

Similarly, based on the measurement report, the source BS may trigger the BS transmitting relaxed signal to transmit full SSB burst or share the PBCH associated with the relaxed signal comprising the PSS and the SSS, to the UE through source BS. When the PBCH associated with the relaxed signal is shared through source BS or transmitted through the other cell or carrier to which the UE may be connected, the UE may perform Downlink (DL) synchronization with the cell that transmits relaxed signal and may directly initiate Random Access Channel (RACH) procedure for Uplink (UL) synchronization after activation of the cell, thus saving time in handover since the UE has already received the full PBCH information through the connected cell or carrier. The trigger may comprise at least one of a measurement report, RACH signal, a low complexity wake up signal, an indication, a Reference Signal (RS), and the identity of the at least one first cell.

In one implementation, when transmitting PBCH through other BS, the target BS divides the information in PBCH into two portions where the first portion of the PBCH (relaxed PBCH) may be transmitted by the target BS in the relaxed signal along with PSS and SSS, where the relaxed PBCH consists of information that are time and beam specific to target BS. In one example, SFN is a BS specific parameter associated with PBCH that specifies the frame number in which PBCH is transmitted. Therefore, target BS may transmit SFN in relaxed PBCH. The parameters in the second portion are either preconfigured by the target BS and is shared with the source BS or may be predefined in standards or transmitted by the BS after receiving a trigger signal. The source BS transmits the shared information to the UE through at least one of control channel, broadcast channel, Medium Access Control Element (MAC-CE), and Resource Control (RRC) message.

In case of transmitting part of PBCH through other cell, the BS may transmit relaxed signal only for certain cells. The BS may transmit second portion of the PBCH associated with the relaxed signal to the UE through other cell or carrier to which the UE is connected. The UE connected to the other cells or carriers of the BS performs measurement of the cell using relaxed signal and reports the measured quantity such as signal quality. The signal quality may comprise at least one of reference signal received power (RSRP), reference signal strength indicator (RSSI), reference signal received quality (RSRQ), and signal to noise plus interference ratio (SINR). Based on the measurement report, the BS may activate the cell. An advantage of partial sharing of PBCH method is reduction in number of bits associated with the relaxed PBCH transmitted by target BS, thereby reducing the number of resource elements (RE) as compared to those used for full SSB transmission thus provide energy saving at BS. Since the UE has the full PBCH information, the UE may perform RACH directly, thus saving time in handover.

In NR, PBCH contains a Master Information Block (MIB) having 24 bits and a PBCH payload having 8 bits. In MIB, the following parameters may be preconfigured and shared with the source BS or may be predefined in standards. The MIB may contain a one bit parameter subCarrierSpacingCommon to select one SCS among two options within FR1 or FR2, for an example between 120 KHz or 240 KHz in FR2, a single bit parameter DMRS-TypeA-Position to select the starting position of Demodulation Reference Signal (DMRS) among the symbols for example, among symbol 2 or symbol 3, 4 bit parameter SSB-subcarrierOffset to indicate the sub carrier offset between the first RE of SSB and start of an common Resource Block (RB), a single bit parameter cellBarred for accessibility of the cell to the UE, a single bit parameter intraFreqReselection to indicate whether intra frequency cell reselection is allowed. The MIB may further contain an 8 bit parameter PDCCHconfig-SIB1 for providing configuration for CORESET 0 and search space 0 from fixed values in tables defined in specs, one bit parameter (spare), and a one bit parameter (BCCH-BCH), to indicate the type of the Broadcast Control Channel (BCCH) message.

In the PBCH payload used for providing unique information specific to the SSB beam, one bit parameter half-frameBit, that indicates the half frame in which the SSB is present, may be preconfigured and shared with serving BS or predefined in standards for energy saving. The parameter associated with SFN, 6 bits parameter SFN in MIB representing 6 MSB bits of SFN, and 4 bits parameter SFN in PBCH payload representing 4 LSB bits of SFN, may be transmitted in relaxed PBCH. In FR2, 3 bits parameter SSB index is used to indicate the SSB beam index in a burst. Thus, 3 bits parameter SSB index may be transmitted in relaxed PBCH. In FR1, the 3 bits parameter SSB index may be shared with the source BS, as it may be used for 1 MSB of 5 bits sub carrier offset with 2 reserved bits. The single bit parameter cellBarred for accessibility of the cell to the UE may also be transmitted in relaxed PBCH if not preconfigured or predefined.

In one scenario, the total number of bits in relaxed PBCH to be transmitted by the BS in the partial PBCH sharing case is 10 bits for FR1 and 13 bits for FR2 as compared to 32 bits in the case of full PBCH transmission in SSB. In another scenario, the relaxed signal may be used to identify a UE switching ON in the coverage region so that BS can transmit SSB for initial access. The relaxed signal contains at least one of PSS, SSS and relaxed PBCH. The UE upon switching ON may receive the relaxed signal and may identify the cell ID and may perform measurement of the cell using relaxed signal. The UE may send the measurement report to the BS in predefined set of resources or may trigger the BS if the signal strength is more than a threshold. The threshold may be determined by the UE based on noise floor or predefined in standards for energy saving. The triggering is done in predefined set of resources or using a low complexity wake up signal.

In case of predefined set of resources, the BS keeps blindly monitoring the resources for response from the UE, whereas the low complex wake-up receiver at the BS senses the wake-up signal transmitted by the UE. Upon detecting the response or wake up signal from the UE, the BS wakes up and starts functioning as a normal active BS that transmits full SSB burst.

In another implementation, the relaxed signal may be used by the UE being served by a source BS or serving cell upon coming in the coverage region so that the connected UE will wake up the target BS to transmit SSB for initial access. The relaxed signal contains at least one of PSS, SSS and relaxed PBCH. The connected UE receives the relaxed signal from the target BS and identifies the cell ID and performs measurement of the cell using PSS and SSS. UE sends the measurement report to the target BS or trigger the BS if the signal strength is more than a threshold in either predefined set of resources or preconfigured resources provided by the source BS/serving cell. The threshold will be determined by the UE based on noise floor or predefined in standards for energy saving or preconfigured and shared to the UEs using the source BS or the serving cells. The triggering may be done using a low complexity wake up signal. In case of predefined set of resources, the BS may blindly monitor the resources for response from the UE, otherwise the low complex wake-up receiver at the BS continuously may sense the wake-up signal transmitted by the UE. Upon detecting the response or trigger signal from the UE, the BS may wake up and start functioning as a normal active BS that transmits full SSB burst.

In one implementation, the BS may transmit SSB in reduced number of time resources to save energy. For an example, the SSB in NR may consist of 4 symbols in time and 20 RBs in frequency, where the PBCH may be transmitted in second symbol, fourth symbol and part of third symbol. The BS multiplexes the PBCH in fourth symbol with second and third symbol without varying the symbol power. Therefore, the modified SSB may consist of only 3 symbols and thereby saving power of the 4th symbol. The bandwidth of the SSB may be increased because of the multiplexing. Therefore, the UE should be capable of supporting higher bandwidth. Power Spectral Density (PSD) may be reduced because of maintaining the same symbol power.

In another implementation, the relaxed SSB transmitted by the BS is transmitted in a smaller number of time resources compared to conventional SSB. The relaxed SSB comprises at least one of PSS, SSS and part of PBCH. Hence relaxed SSB has less information content compared to conventional SSB and can be transmitted in less number of time resources without increase in bandwidth. The advantage of transmitting in reduced number of time resources is increase in duration of inactivity/sleep. For e.g., consider a BS operating in sleep mode or deactivated state for all instances except instances for performing basic operations like SSB. In case of reducing the time span of SSB, the time gap increases between two SSB transmissions and the BS can operate in sleep/deactivated state for longer duration, resulting in higher energy saving.

The PBCH may be multiplexed with SSS such that the SSS may occupy one of REs at the beginning of the third symbol, the REs at the end of the third symbol, and the REs in between the REs occupied by PBCH. PBCH is not multiplexed with Primary Synchronization Signal (PSS), so that the UE may decode the PSS properly for time synchronization. Further, energy saving may be achieved by reducing sequence length of the PSS, thereby reducing the number of REs required for the PSS. The power saved by reduced PSS sequence length may be used for multiplexed PBCH and SSS.

Table 1 illustrates a modified SSB structure. As illustrated in Table 1, length of the modified SSB is 3 symbols with SSS occupying REs at the start of symbol 3.

TABLE 1

| Symbol 1 | Symbol 2 | Symbol 3 |
|---|---|---|
| Reduced | Increased PBCH band | Increased PBCH band to |
| PSS | to accommodate more | accommodate more PBCH |
| | PBCH REs and PBCH- | REs and PBCH-DMRS |
| | DMRS | Guard Band |
| | | SSS in beginning REs of SSB |

In another implementation, the BS may activate sleep state to reduce energy consumption. In sleep state a BS completely/partially switches off its operations or components. For an instance, BS may transmit only SSB or the SSB may be transmitted by the BS based on the trigger from network, other BSs or the UE. The activation of sleep state or suspending certain operation is based on various parameters of the network and the BS. E.g., when the load of the BS or number of UEs connected to a cell is very less then BS deactivate that cell. A suspended cell may be switched on upon increment in number of users in active cells or based on a trigger or wake up indication from other entities in the network.

In one implementation, the trigger from other active BS or network BS may be based on an assistance information from their connected UEs. One of the network or the active BS may configure a set of resources to their UE for the assistance information and get the location and direction of movement of their connected UE as the assistance information from the UE. At least one of the network, active BS or the UE may trigger the sleeping or switched off BS based on the location and direction of movement of the UE. At least one of the network, active BS or the UE may trigger more than one BS in case of not identifying the exact direction of movement and location of UE or a case where there is a high density of BSs in the proximity. After receiving the trigger, the BS may start operating with basic functionality. The BS may fall back to sleep or an off state if proper communication is not received after certain duration of time. The trigger signal for waking up the BS from sleep state may be achieved differently based on different use cases. A resource for transmitting the trigger signal may be predefined in standards, obtained from the relaxed signal, configured by at least one first node, and preconfigured by at least one third node. The at least one third node may comprise one or more of at least one IAB node, at least one distributed unit (DU), at least one mobile termination (MT) unit, at least one relay and at least one BS. The preconfigured resources may be in terms of an ON cycle in which the BS in the sleep state will switch ON periodically and monitor for trigger signal in certain time-frequency resources. The BS, before entering into the sleep state, may inform the network or other BS about the ON cycle of BS, type of sleep state, preconfigured resources to transmit the trigger, and their validity in time. The timing synchronization between the BSs is essential for the BS to read the information shared by the BS entering sleep state, and the synchronization may be achieved with the help of network, global positioning system (GPS), or any other technique.

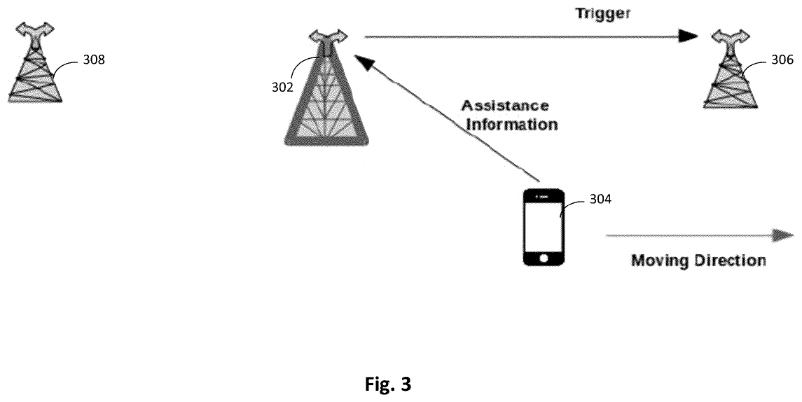

FIG. 3 illustrates the Base Station triggering another BS, in energy saving mode, based on assistance information from the connected UE, in accordance with first embodiment of the present invention. As illustrated in FIG. 3, BS2 302 is in active state and serves a UE 304, and BS1 306 and BS3 308 are neighbouring BSs in switch off or sleep mode, The ON cycle of BS1 306 may be defined and may be communicated to BS2 302 before going to switch off or sleep mode. The BS2 302 may get the signal quality, location and moving direction of the connected UE. If signal quality of the UE 304 is degrading and the moving direction of UE 304 is towards BS1 306, then BS2 302 may send trigger signal to BS1 306. The BS1 306 may start transmitting SSB, BS2 302 may configure UE 304 to measure the signal transmitted by BS1 306 and initiate hand over procedure with BS1 306 based on measurement report. If handover request is not received within specific time duration, then BS1 306 goes to switch off or sleep mode. In case there are multiple BS in off or sleep mode then BS2 302 triggers more than one BS based on location and direction of movement of the UE 304.

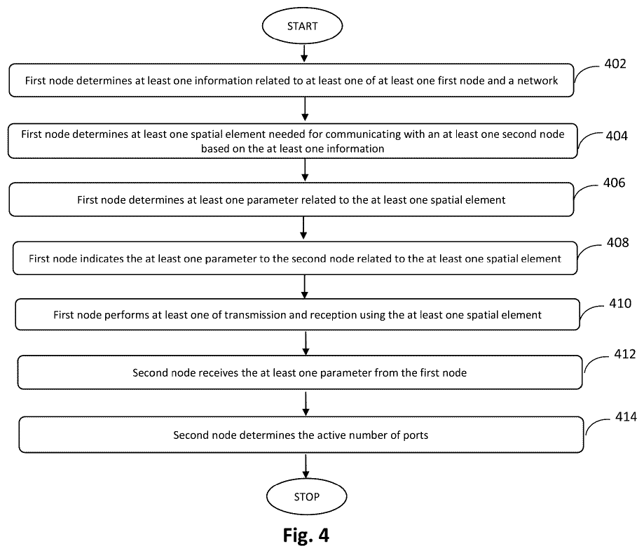

The trigger from a new UE may be a signal broadcasted by the UE representing its presence upon switching ON. The trigger signal may be transmitted in predefined resources in standards for energy saving or the BS equipped with a dedicated sensor to sense the trigger signal. The BS may switch ON and monitor for trigger signal based on predefined time-frequency resources. The trigger signal broadcasted by the UE may be one of a cell ID obtained by the measurement of a signal transmitted by the BS, a predefined sequence, an UL-RS and a parameter or sequence associated with the DL signal transmitted by the BS. In a second embodiment of the present invention, a method of energy saving in a cellular network comprises adapting by the BS the number of spatial elements used for transmission and reception based on parameters of the network and indicating active antenna ports at a BS to a UE. FIG. 4 illustrates a method for adapting the spatial elements used for transmission and reception at the BS and its indication to the UE, in accordance with the second embodiment of the present invention. At step 402, at least one information related to one or more of at least one first node and a network may be determined. The at least one first node may comprise one or more of at least one BS, at least one IAB node, at least one relay, and at least one DU. The at least one information may comprise at least one of load, traffic conditions in the network, channel conditions between the at least one first node and the at least one second node, number of second nodes connected to the at least one first node, location of the at least one second node, deployment scenario, UE arrival rate and types of the at least one UE. The at least one first node, at step 404, may determine at least one spatial element from the plurality of spatial elements, needed for communicating with at least one second node based on the at least one information. The at least one spatial element from the plurality of spatial elements may include an active number of ports in the network. Determining the at least one spatial element from the plurality of spatial elements may also include one or more of deactivating at least one spatial element from a plurality of spatial elements based on the at least one information, and deactivating at least one port from a plurality of ports based on the number of spatial elements. The at least one second node may comprise one or more of at least one UE, at least one IAB, at least one DU, at least one MT unit, at least one relay, and at least one BS.

The at least one first node, at step 406, may determine at least one parameter related to the at least one spatial element. The at least one first node, at step 408, may indicate to the at least one second node, the at least one parameter related to the at least one spatial element. The at least one parameter may include at least one of active number of ports, indices of active number of ports, maximum number of ports active at a time, index of maximum number of ports active at a time and variation in number of ports. The at least one first node, at step 410, may perform at least one of transmission and reception using the at least one spatial element. Performing at least one of transmission and reception may include one of deactivating at least one spatial element from a plurality of spatial elements based on the at least one information and deactivating at least one port from a plurality of ports based on the number of spatial elements. The at least one second node may at step 412 receive the at least one parameter from the at least one first node. The at least one second node at step 414 may determine the active number of ports. The active number of ports may be less than the maximum number of ports active at a time.

In one scenario, the BS should inform the UE about the active number of ports or variation in the number of ports, so that unnecessary processing for removed ports may be avoided at the UE. For an example, the at least one Channel State Information-Reference Signal (CSI-RS) resource may be semi-statically configured by the BS to the UE to measure parameters related to the channel. The at least one CSI-RS resource configuration may be associated with a number of ports, indicating a set or a number of spatial elements used by the BS to transmit the at least one CSI-RS resource. The adaptation of spatial elements leads to deactivation of certain number of ports which in turn may lead to deactivation of the at least one CSI-RS resource configured. If the UE is aware of the active number of ports, then the UE may identify the at least one CSI-RS resource deactivated and skip monitoring those resources. The active number of ports may be a difference between total number of ports and number of ports to be deactivated by the at least one first node, a difference between total number of ports and number of ports deactivated by the at least one first node, based on the spatial elements to be deactivated, and based on the deactivated spatial elements.

The at least one parameter may include at least one CSI-RS resource, from a plurality of CSI-RS resources, corresponding to one of active number of ports and the deactivated number of ports. For an example, the BS may configure three CSI-RS resources to the UE, each corresponding to 2, 4 and 8 ports. After adapting the spatial elements, the BS may operate with only 2 and 4 ports. Therefore, the BS may not transmit the third CSI-RS resource corresponding to 8 ports. In that case, the BS may indicate the CSI-RS ID corresponding to the third resource (deactivated resource) to the UE.

The BS may indicate the maximum number of ports active at a time to the UE as the at least one parameter, using which the UE may identify the active CSI-RS resources. In one implementation, the UE may monitor and measure only those CSI-RS resources that correspond to lesser number of ports than the maximum indicated value. For an example, the UE may be semi-statically configured with a resource set having resources corresponding to 2, 4, 16 and 32 ports, and the BS may dynamically indicate the maximum number of ports active at the time that is 4, then UE may monitor for the CSI-RS only in those resources corresponding to 2 and 4 ports.

In another implementation, the BS may indicate index corresponding to maximum number of ports active at a time to the UE as the at least one parameter. Number of bits required to indicate the index corresponding to maximum number of ports active is ceil {Log₂(M)}. M may denote the number of possible options for transmission of CSI-RS ports. In an instance, the NR has 8 options for CSI-RS ports which are {1, 2, 4, 8, 12, 16, 24, 32}. Therefore, a total of ceil {Log₂(8)} that is equal to 3 bits are needed to signal index corresponding to the maximum value of number of port that is active. For an example, an indication of 5 (101) implies maximum number of ports active is 16, corresponding to index 5.

In one implementation, the BS may also indicate a time offset between time at which indication of the at least one parameter is transmitted and time at which number of spatial elements is varied. The offset may either be signalled along with indication of at least one parameter or predefined in standards. In one instance, the BS may indicate to the UE, maximum number of ports active as 4 in slot n and may increase or decrease the maximum number of ports as 4 in a slot (n+k), k value may either be explicitly signalled by the BS to the UE in slot n or may be defined as a fixed value in the standards. The indication of at least one parameter to the UE may be valid until UE receives another indication or the UE receives a deactivation command. Validity of the indication of the at least one parameter may either be specified by one of indicated by the BS along with the at least one parameter, an indicated at least one parameter is applicable until the UE receives new indication of the at least one parameter, and an indicated at least one parameter is applicable until a deactivation command is received.

In one implementation, to avoid the UE to unnecessarily measure all the resources in the resource set, the BS may trigger only the resources in the resource set that corresponds to the active number of ports. The at least one parameter may be indicated using a bitmap. The bitmap may be used to indicate the at least one active CSI-RS resource corresponding to the active number of ports from the plurality of CSI-RS resources within the resource set. The bitmap may also indicate at least one active number of port from the plurality of ports. At least one bit of the bitmap is set when one of a port of the plurality of ports and a CSI-RS resource of the plurality of CSI-RS resources, is active. The at least one bit of the bitmap is reset when one of a port of the plurality of ports and a CSI-RS resource of the plurality of CSI-RS resources, is inactive.

Total number of bits required for the bitmap is equal to one of the total number of resources present in the selected resource set and the total number of options for the number of ports. The bitmap indication may be transmitted using at least one of MAC-CE or DCI. Table 2 illustrates a bitmap for active number of ports in a resource set with 4 resources. As illustrated in Table 2, the resource set with 4 resources corresponds to a maximum number of ports equal to 8. If the BS dynamically adapts the maximum number of ports as 4, then the BS signals the bitmap as 1110 so that resource ID3 corresponding to 8 ports is disabled and avoided for monitoring by the UE.

TABLE 2

| Resource IDs in | | |
|---|---|---|
| resource set | Ports per resources | Bitmap |
| 0 | 1 | 1 |
| 1 | 2 | 1 |
| 2 | 4 | 1 |
| 3 | 8 | 0 |
| Total 4 resources | | Final bitmap 1110 |
| in resource set | | |

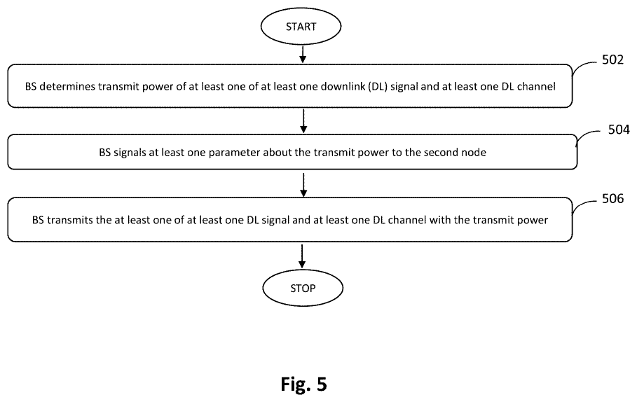

FIG. 5 illustrates a method of adapting the transmit power of a signal/channel of a power offset by a BS to a UE, in accordance with second embodiment of the present invention. At step 502, a transmit power of one or more of at least one downlink (DL) signal and at least one DL channel may be determined by the BS. At least one parameter about the transmit power may be signalled at step 504, to at least one second node. The at least one parameter may be at least one of a multiplication factor, a value of a power offset and a type of power offset. The multiplication factor may be applied to the power offset and the power offset may be determined by the type of power offset. At step 506, one or more of at least one DL signal and at least one DL channel may be transmitted with the transmit power. The transmit power may be determined based on at least one of interference strength, location of the at least one second node, deployment scenario, types of the at least one second node, and channel condition between the at least one first node and the at least one second node.

Code Division Multiplexing (CDM) group is a group of either 2 or 4 Resource Elements (REs) where orthogonal cover coding may be used in time and/or frequency domain to enable multiple Demodulation Reference Signal (DMRS) ports. The Downlink (DL) power across symbols may be kept constant and the DMRS power may be increased if extra power is available when data is not present in the symbol. The increment may be fixed in standards for example in NR DL, the power of DMRS may be increased twice or thrice compared to power of data based on the number of CDM groups without data. Further, the Reference Signal (RS) power may be configured based on requirement and may be semi-statically signalled to the UE as a power offset in the RRC. The power offset is a ratio of power per RE between the one or more of at least one downlink signal and at least one downlink channel. The power offset may be in the form of a ratio between data power per RE to the RS power per RE.

In one implementation, for a RS, a type of power offset is one of a ratio of power per Resource Element (RE) between Channel State Information-Reference Signal (CSI-RS) and PDSCH, a ratio of power per RE between the CSI-RS and the SSB, and a ratio of power per RE between Demodulation Reference Signal (DM-RS) and PDSCH. The power offsets for the CSI-RS may have a range of fixed values in specification and a selected value from the range may be given by the RRC as the power offset to the UE, for an example, 3 dB offset.

However, the RS power may be changed depending on one or more of channel condition and interference. The channel condition and the interference may vary dynamically. In one implementation, RS power may be varied dynamically to increase flexibility. The BS may decide a multiplication factor for the UE based on a variation in the transmit power of one or more of at least one DL signal and at least one DL channel. The DL channel may be one of PBCH, PDSCH and PDCCH. The DL signal may comprise one of Primary Synchronization Signal (PSS), Secondary Synchronization Signal (SSS), DMRS, SSB and CSI-RS. The transmit power of one or more of at least one DL signal and at least one DL channel may be multiplied with the multiplication factor for accurate measurement of downlink signals at the at least one second node. The at least one first node may comprise one or more of the at least one BS, the at least one IAB node, the at least one relay, and at least one DU. The at least one second node may comprise one or more of the at least one UE, the at least one IAB node, the at least one distributed unit DU, the at least one MT unit, the at least one relay, and the at least one BS.

In one implementation, the RS power may be multiplied with the multiplication factor signalled by BS. The value of the multiplication factor may be a value ranging from 0 to 1. In one scenario, a multiplication factor may have a value of 0.5 corresponding to a 1.5 dB decrement in the pre-configured and allotted power offset value of 3 dB, in case of low load, low interference, and good channel conditions. A high multiplication factor value may have a value of 1 for 3 dB increment in the RS power as equal to the alloted power offset value, when channel condition is poor. The multiplication factor may be signalled to the UE dynamically. The signalling may be performed using at least one of control channel, broadcast channel, and MAC-CE. The multiplication factor may be signalled to the UE in DCI for accurate measurements.

In a third embodiment, when there are time instances where the BS does not have anything to transmit or receive and the BS may dynamically switch off the operation for a duration of time and activate sleep state to save energy, connected UEs may be informed about the sleep state of the BS to save energy. The UEs may be informed about the sleep state of the BS in terms of starting time and duration. The starting time and duration may be in terms of number of symbols, slots, sub-frames or frames. The sleep states may be defined and the parameters associated with the sleep states may be predefined and signalled to the UE semi-statically. In order to signal the UE, the BS may signal the sleep state and the starting time to the UE dynamically. For an example, micro sleep state may be defined with duration of 1 ms and signalled to UE semi statically. In slot n, the BS may dynamically inform the UE about activation of micro sleep from slot n+5.

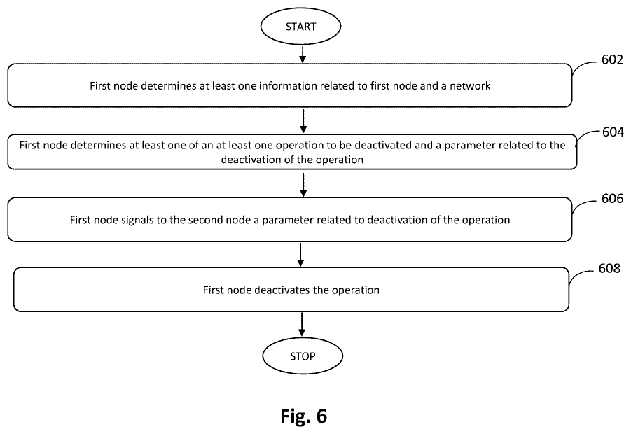

FIG. 6 illustrates a method of activating sleep state by the BS, in accordance with the third embodiment of the present invention. At step 602, at least one information related to one or more of the at least one first node and a network may be determined. The at least one first node may comprise at least one of the at least one BS, the at least one IAB node, the at least one relay, and the at least one DU. The at least one information may be at least one of channel conditions, UE arrival rate, deployment scenario, number of connected UEs, traffic and load on the at least one first node. Based on the at least one information, the at least one first node at step 604, may determine one or more of at least one operation to be deactivated, and at least one parameter related to the deactivation of the operation.

Some signals and channels with high priority and importance, may not be deactivated by the BS. In such a scenario, the BS may indicate to the UE about a priority rule, so that the UE may perform transmission and reception of indicated signals and channels in the duration of deactivation. For an example, the SSB is a high priority signal and may be indicated in the priority rule. The at least one parameter may include one or more of the at least one operation, starting time of the deactivation, duration of the deactivation, type of deactivation, the priority rule, indication for re-assignment of time resource associated with deactivation, and beam ID (SSB index). The priority rule may comprise performing one or more of transmission and reception of the at least one signal in a resource overlapping with duration of deactivation. The at least one signal may comprise at least one of RS, data channel, control channel, PSS, SSS and PBCH.

The indication for re-assignment may be for informing to the at least one second node to re-assign the time resource and performing the at least one operation based on the reassigned time resource. The at least one of the starting time of the deactivation, duration of the deactivation, and indication for re-assignment of time resource associated with deactivation is indicated in terms of multiple of at least one of symbols, slots, sub-frames and frames. The multiple of at least one of the symbols, slots, sub-frames, and frames may be indicated as at least one of a symbol index, a slot index and a number. The at least one of the starting time of the deactivation and the duration of the deactivation may be one of a dynamic value, one or more preconfigured value, and a value chosen from a set of predefined values. The type of deactivation may be predefined. The type of deactivation may comprise at least one of duration of deactivation, at least one of operations, signals and components deactivated, and the priority rule. The signals may comprise at least one of SSB, RACH, control channel, data channel and RS.

The at least one first node may signal at step 606, to at least one second node, the at least one parameter related to the deactivation of the operation. The at least one second node may comprise at least one of the UE, the at least one IAB node, the at least one DU, the at least one MT unit, the at least one relay, and the at least one BS. The at least one first node at step 608 may deactivate the at least one operation. The deactivation may be applicable for one or more of at least one cell, at least one beam, at least one carrier, and at least one sector. The operation may comprise at least one of the transmissions of at least one of the SSB, the control channel, the data channel, and the RS. The operation may also comprise at least one of the receptions of at least one of RACH, control channel, the data channel, and the RS. The one or more of signalling and deactivating may be either semi-static or dynamic. The signalling may be done using at least one of DCI, broadcast channel, Medium Access Control Element (MAC-CE), and Radio Resource Control (RRC) message.

The at least one second node may receive the at least one parameter related to deactivation of the operation. The at least one second node may perform the at least one operation based on the at least one parameter related to deactivation of the operation. Performance of the at least one operation may comprise at least one of skipping the at least one operation and re-assigning the time resource. In one implementation, the BS may inform the UE about an off-time duration. During the off-duration, the UE may skip the transmission and the reception of signals configured in slots in which the BS is off. For an example, if the BS is in off from slot 5 to slot 8 and the UE is configured to receive CSI-RS in slot 5, then the UE will not monitor for CSI-RS in slot 5. In case of reassignment of the time resource, the at least one second node performs the at least one operation based on the reassigned time resource. For e.g., if BS is in off from slot 5 to slot 8, the UE is configured to receive CSI-RS in slot 5 and UE received an indication to offset the slot index by 4 slots, then slot 5 will be reassigned as slot 9 and the CSI-RS reception will be performed in slot 9.

In another implementation, the at least one first node may reactivate the at least one operation upon reception of a trigger signal. The trigger signal may be broadcasted or transmitted to the at least one first node. The at least one first node may receive the trigger signal from one or more of at least one third node and the network. The at least one third node may comprise at least one of the at least one active BS, the at least one IAB node, the at least one DU, the at least one relay, and at least one UE. The UE may be one of a connected UE, a non-connected UE, an inactive UE, and a new UE searching for a new BS.

In another implementation, the BS may inform the UE about the off-time duration of the BS and may re-assign the time resource to the UE, so that the slot indices in the off-duration are not counted. For an example, if the BS may be in off-duration from slot 5 to slot 8, then the BS may inform the UE about the off-duration and reassign the slot index 9 as slot index 5. The at least one first node may perform the at least one operation based on the reassigned time resource. Referring back to the example, the UE may operate with the re-assigned slot index and may resume the configured processes normally with the re-assigned slot index. When the BS was in off-duration from slot 5 to slot 8 and the UE was configured to receive CSI-RS in slot 5, then the UE may monitor for CSI-RS in the slot 9. During the BS off-duration, the UE may not be expected to transmit or receive the signals, thereby saving power of the UE as well. The at least one first node may also reschedule the at least one operation in a first available active time resource after the duration of the deactivation.

In the third embodiment, the trigger signal may be received by the at least one of the first node in a set of resources. The set of resources may be one of predefined in standards and configured to the at least one third node. The set of resources may comprise at least one of time resources, frequency resources, spatial resources, periodicity, and validity of the resources. The spatial resources may comprise at least one of SSB index, beam index, beam pair index, Reference Signal Index (RS-ID). The periodicity may comprise an ON cycle in which the at least one first node will switch ON for a predefined time duration at intervals to monitor the trigger signal. The set of resources may be configured to the at least one third node by one of the at least one first node, the at least one second node, or the network. The at least one the first node may inform one of at least one second and network about the configured set of resources. The at least one third node may transmit the trigger signal based on at least one of measurement of a signal transmitted by the first node, signal quality of at least one UE connected to the third node, and assistance information from the at least one UE connected to the third node.

The at least one third node may transmit the trigger based on at least one of measurement of a reference signal transmitted by the at least one first node, signal quality of at least one UE connected to the third node, and assistance information from the at least one UE connected to the third node. The assistance information may be at least one of location and direction of movement of the at least one UE. The at least one third node may be time synchronized with the at least one first node.

In another embodiment, the trigger signal may also be received by the at least one of the first node in a dedicated receiver to receive the trigger signal. The one or more of the at least one third node, and the network may transmit the trigger to a plurality of first nodes.

In the third embodiment, the trigger signal may be one of a measurement report of the DL signal received from the first node, a signal representing presence of a new UE upon switching ON, a predefined sequence, an indication signal, and a Sounding Reference Signal (SRS). The measurement report may comprise at least one of quality of the received DL signal, Identity (ID) of the received DL signal, sequence of the received DL signal, and a parameter received in the DL signal. The at least one first node may deactivate the at least one operation when no communication is established with at least one node within a duration of time after the reception of the trigger.

The sleep state of the BS or a time domain switch off state of the BS impacts related processes of the BS. In one scenario, the sleep state of the BS may impact the Hybrid Automatic Repeat Request (HARQ) codebook. The HARQ mechanism is a retransmission protocol in which a receiver checks for errors in received data and if an error is detected then the receiver buffers the data and request retransmission from the transmitter. Later, the retransmitted data is combined with the buffered data prior to channel decoding and error detection to improve performance of retransmission. The complete cycle of transmitting data, receiving data at other end, processing data, and sending feedback is known as HARQ process. The BS has to wait till reception of positive HARQ feedback to transmit new data to the UE that creates latency due to propagation delay between the BS and the UE. To avoid latency, parallel data transmissions are initiated at the BS without waiting for acknowledgement from the UE, where each parallel data transmission is identified using HARQ identity. The UE will multiplex feedback corresponding to more than one HARQ process at a time and is known as HARQ codebook. In 5G systems, 3GPP has specified three different types of HARQ codebooks namely, Semi-static HARQ codebook, Dynamic HARQ codebook and one-shot HARQ codebook.

A semi-static HARQ codebook (SSCB), as the name suggests, is the codebook that is formed based on the information given to the UE semi-statically. BS semi-statically configures a set of values to a UE, which represent the offset between the slot carrying downlink (DL) data and the slot carrying the corresponding HARQ feedback. The offset is denoted as ‘K1’ in this document. The HARQ feedback is transmitted for all the candidate occasions irrespective of whether the DL data is scheduled or not in the candidate occasions. The candidate occasions corresponding to a slot carrying HARQ feedback is obtained by counting back the semi statically configured set of K1 values from the occasion for transmission of HARQ feedback. E.g., if {2, 4, 5, 8, 10} indicate semi statically configured set of K1 values and HARQ feedback is scheduled in slot n, then the candidate occasions corresponding to HARQ feedback in slot n are obtained as {n−2, n−4, n−5, n−8, n−10}. Therefore, the size of the semi-static HARQ code book is related to the configured set of K1 values. Among the candidate physical downlink shared channel (PDSCH) occasions, ACK/NACK is inserted in the codebook for the slot with scheduled DL data based on the success/failure of that DL data whereas NACK is transmitted for the slot that are unscheduled. The advantage of semi-static codebook is that it is not affected by the DCI failure. Dynamic HARQ codebook is an alternate approach introduced to reduce the size of HARQ codebook.

A BS may activate sleep state for certain duration to save energy consumption. When a UE may be configured to transmit SSCB and a candidate occasion corresponding to the HARQ feedback fall in slots and/or symbols in which the BS may be in the sleep state. In this case, the UE may unnecessarily transmit HARQ feedback for a slot in which BS was not operational. The BS may inform the time duration of sleep state to the UE and the UE may treat a time resource overlapping with the time duration of sleep state as non-candidate slot for the SSCB and should not send HARQ feedback corresponding to those time resources.

The at least one second node may update the size of a HARQ codebook based on the at least one parameter related to deactivation. The updating of the size of the HARQ codebook may comprise determining whether the at least one operation may comprise transmission of data signals by the at least one first node. The at least one candidate slot corresponding to the HARQ codebook may determine overlapping with the duration of deactivation. The feedback for at least one candidate slot in the HARQ codebook may be skipped.

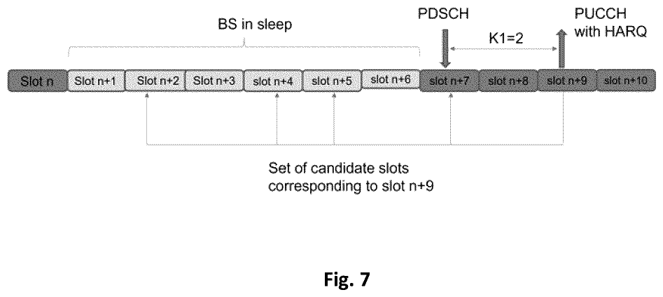

FIG. 7 illustrates an impact of sleep state at BS on semi-static HARQ code book, in accordance with a third embodiment of the present invention. When the BS is in sleep from slot n+1 to slot n+6, and a DCI had scheduled DL data to a UE in slot n+7 and indicated k1=2. Therefore, the UE has to send feedback for DL data in slot n+9. If the UE may be semi-statically configured with set of offset values {2, 4, 5, 7}, then the candidate occasions corresponding to the slot n+9 may be {slot n+7, slot n+5, slot n+4, slot n+2}, out of which the BS was active only in slots n+7. Conventionally, based on the current specification, in SSCB, the UE may have to transmit feedback in all four candidate occasions irrespective of whether the BS is active or sleep. However, in one implementation of the present invention, the BS may inform the UE about the sleep state, using which the UE may identify that the candidate occasions slot n+2, slot n+4 and slot n+5 falls in the sleep duration of BS and does not include feedback for these set of slots in SSCB. Therefore, the SSCB corresponding to the slot n+9 may consist of feedback corresponding to slot n+7 alone.

In another scenario, when the BS may be in sleep state in the slot in which HARQ feedback may be configured from the UE. The UE may not transmit any HARQ codebook in those slots and the BS may treat that occasion as UL failure and reschedule HARQ transmission after the duration of sleep.

In another scenario, sleep state of the BS may impact an Integrated Access and Backhaul (IAB) network. The IAB node may communicate in access and backhaul links using same wireless technology and dynamically shares same set of resources for communication in both the links. The IAB node consist of two parts, namely the MT and the DU. The MT part communicate with another BS or IAB node or central unit using backhaul link, and the DU part communicate with another IAB node or UE using access link. To enable dynamic sharing of resources among access and backhaul links, new resource types has been defined for DU part of IAB nodes, namely hard, soft and not available. The DU of IAB node can transmit or receive in a resource configured as hard, whereas DU of IAB node require additional signalling to transmit or receive in a resource configured as soft. The additional signalling, termed as Indication of Availability (IA), is provided by the node connected to MT of the IAB node. Finally, the DU of IAB node cannot transmit or receive in a resource configured as not available.

The at least one second node may derive an Indication of Availability (IA) for at least one soft resource based on the at least one parameter related to deactivation. Deriving the IA may comprise determining whether the at least one operation comprises at least one of transmission and reception. Deriving the IA may also comprise determining the at least one soft resource overlapping with the duration of deactivation. Deriving the IA may further comprise deriving IA for the at least one soft resource.

If a BS activates sleep state for certain resources to save energy consumption and the BS is serving an IAB node, then the BS may not communicate with the MT part of the IAB node during the sleep state. However, the BS may signal the type of sleep state and the at least one parameter to the IAB node. The IAB node may treat the signalling as IA and the DU part of the IAB node may use the resource to communicate with connected IAB nodes or UEs. For an example, the BS may activate sleep state from slot 5 to slot 10 and indicate the sleep state to an associated IAB node. So, BS may not communicate with the MT of the IAB node in slot 5 to slot 10. The IAB node may treat the indication from the BS as IA, so that DU of the IAB node may communicate with the UE or another IAB node in slot 5 to slot 10.

In another scenario, the sleep state of the BS may impact transmission of an SSB. The SSB is an important DL signal necessary for initial access, handover, and cell re-selection procedures. When the BS may activate the sleep state for a time duration for energy saving, the configured SSB which falls in the slots and/or symbols in which the BS is in sleep state may be skipped. If the slot index is not reassigned, the measurement process using SSB at the UE may be delayed. Additionally, an initial access for the new UEs may be delayed if the SSBs are skipped in off-duration. Thus, the SSB may be transmitted after the off-duration immediately without causing much impact to SSB configurations and other specifications. The skipping of SSB may be avoided with minimum specification impact, if the off-duration is not more than the half frame size, then the skipped SSB burst of a frame may be shifted to the other half of the frame.

The signalling by the at least one first node to the at least one second node, the at least one parameter related to the deactivation of the operation, may comprise one of at least one of shifting a transmission of SSB to the other half frame, updating a one bit parameter half frame bit in a PBCH, and informing the at least one second node about the shifting operation. The transmission of the SSB may also be shifted to a first active time resource after the duration of the deactivation. Shifting the transmission of the SSB to the other half frame may be performed when the duration of the deactivation of operations is less than half frame size. The transmission of the SSB may overlap with duration of deactivation of operations and can be shifted. The at least one second node may then be informed about the shifting operation.

In order to shift the skipped SSB burst, a change in a one-bit parameter half-frame bit within PBCH may be utilised. The half-frame bit may be used to identify the half part of the frame where the SSB burst may exist after the shift. For an example, when the SSB is configured in first half of the frame, then the skipped SSB burst of a frame may be shifted to the second half of the frame and the half frame bit may be changed accordingly. Similarly, when the SSB is configured in second half of the frame, then the skipped SSB burst of a frame may be shifted to the first half of the frame and the half frame bit may be changed accordingly. When the SSB is shifted in other half of the frame, a System Frame Number (SFN) will not change as the SSB may remain in the same frame. The BS may explicitly inform about the shifting adoption to the connected UEs for measurement. The UE may then measure the SSB on the indicated half frame based on the information received by the BS. When the slot index is reassigned and is informed to the connected UEs along with time duration of sleep state of the BS, the operation of the SSB will be resumed after the off-duration with the reassigned slot at the BS and the connected UE may then resume their measurement on SSB accordingly. The signaling in the process may be done by at least one of physical layer signaling, MAC or RRC.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method of adaptation of signals and channels in a cellular network, the method comprising:
determining at least one information related to one or more of at least one first node and a network;
adapting, by the at least one first node, transmission pattern of at least one Synchronization Signal Block (SSB); and
signalling, by the at least one first node, at least one parameter related to the adaptation to at least one second node.

2. The method as claimed in claim 1, wherein the at least one first node comprises one or more of at least one Base Station (BS), at least one Integrated Access and Backhaul (IAB) node, at least one relay, and at least one Distributed Unit (DU).

3. The method as claimed in claim 1, wherein the at least one second node comprises one or more of at least one User Equipment (UE), at least one IAB node, at least one DU, at least one Mobile Termination (MT) unit, at least one relay, and at least one BS.

4. The method as claimed in claim 1, wherein the at least one information comprises one or more of load, traffic conditions, channel conditions, number of second nodes connected to the at least one first node, the buffer status of the at least one second node, types of the at least one second node, deployment scenarios, and UE arrival rate.

5. The method as claimed in claim 1, wherein the signalling is using at least one of Radio Resource Control (RRC) message, Medium Access Control Element (MAC-CE), control channel, broadcast channel, sidelink channel, and Xn interface.

6. The method as claimed in claim 1, wherein adapting the transmission pattern comprises varying the periodicity of one of:
at least one SSB beam from a plurality of SSB beams of an SSB burst;
at least one SSB group of an SSB burst; and
at least one SSB beam of at least one SSB group of an SSB burst.

7. The method as claimed in claim 6, wherein the SSB beams having same SSB order in plurality of groups are assigned with same periodicity.

8. The method as claimed in claim 1, wherein the parameter comprises one or more of at least one periodicity, at least one index value, and a granularity of varying the periodicity, and wherein granularity comprises one of beams and SSB groups in the SSB burst.

9. The method as claimed in claim 8, wherein the index value is at least one of beam index and group index.

10. The method as claimed in claim 8, further comprising an indication for reusing the at least one periodicity across the SSB groups.

11. The method as claimed in claim 1, wherein the at least one parameter is represented using ceil {M Log₂(N)} bits, wherein M denotes at least one of maximum number of group and number of beams, and N denotes total number of options for periodicity.

12. A method of adaptation of signals and channels in a cellular network, the method comprising:
determining, one or more information related to at least one first node and a network; and
transmitting, by the at least one first node, a relaxed signal in at least one first cell, wherein the relaxed signal is transmitted in less number of at least one of time and frequency resources than the resources used for an SSB.

13. The method as claimed in claim 12, wherein the at least one first node comprises one or more of at least one base station BS, at least one IAB node, at least one relay and at least one DU.

14. The method as claimed in claim 12, wherein the at least one information is one or more of load condition, traffic conditions, channel conditions, number of at least one second nodes connected to the at least one first node, the buffer status of the at least one second node, types of the at least one second node, deployment scenarios and UE arrival rate.

15. The method as claimed in claim 14, wherein the at least one second node comprises one or more of at least one User Equipment (UE), at least one IAB node, at least one mobile termination (MT) unit, at least one relay, and at least one BS.

16. The method as claimed in claim 15, wherein the at least one UE is one of a connected UE, a non connected UE, an inactive UE, and a new UE searching for a new BS.

17. The method as claimed in claim 12, wherein the relaxed signal comprises at least one of Primary Synchronization Signal (PSS), Secondary Synchronization Signal (SSS), a first portion of Physical Broadcast Channel (PBCH), a threshold value and scheduling for a trigger signal.

18. The method as claimed in claim 17, wherein the first portion of PBCH comprises at least one parameter related to at least one of time domain characteristics and beam specific characteristics of the relaxed signal.

19. The method as claimed in claim 17, wherein the first portion of PBCH comprises at least one of system frame number, cell barring indication and SSB index.

20. The method as claimed in claim 17, wherein the second portion of PBCH is one of:
predefined in the standards,
broadcasted by at least one first node,
transmitted to the at least one second node by at least one third node, or
transmitted to the at least one second node through at least one second cell.

21. The method as claimed in claim 20, wherein the at least one third node comprises one or more of at least one IAB node, at least one DU, at least one Mobile Termination (MT) unit, at least one relay, and at least one BS.

22. The method as claimed in claim 20, wherein the second portion of PBCH comprises parameters related to at least one of frequency domain characteristics of relaxed signal, time domain characteristics of relaxed signal, scheduling of demodulation reference signal (DMRS), scheduling for control channel, broadcast channel specific characteristic, beam specific characteristics, availability of the cell, and cell specific parameters.

23. The method as claimed in claim 20, wherein the second portion of PBCH comprises at least one of sub carrier spacing, DMRS position, subcarrier offset between SSB and common resource block, cell barring indication, intra frequency reselection, configuration for control resource set zero, configuration for search space zero, spare bits, type of broadcast channel, and indication for half frame with SSB.

24. The method as claimed in claim 20, wherein the at least one first node shares the second portion of PBCH to the at least one third node.

25. The method as claimed in claim 20, wherein the second portion of PBCH is transmitted through at least one of control channel, broadcast channel, Medium Access Control Element (MAC-CE), and Resource Control (RRC) message.

26. The method as claimed in claim 20, wherein the at least one second cell is a carrier.

27. The method as claimed in claim 12, wherein the at least one first cell is a carrier.

28. The method as claimed in claim 12, wherein the relaxed signal comprises at least one of:
multiplexed PBCH information of fourth symbol and at least one of the second symbol and third symbol of an SSB, and
reduced length PSS sequence in the SSB.

29. The method as claimed in claim 28, wherein the relaxed signal is meant for power control.

30. The method as claimed in claim 12, further comprises transmission by the at least one first node, one of:
the second portion of PBCH,
the full PBCH associated with the relaxed signal,
command to use the predefined values of the second portion of PBCH, or
an SSB.

31. The method as claimed in claim 12, further comprising receiving by the at least one first node a trigger signal from one or more of at least one second node, the network and at least one third node, wherein the trigger signal is at least one of a measurement report, a Random Access Channel (RACH) signal, a low complexity wake up signal, an RS, the identity of the at least one first cell, and a one bit indication.

32. The method as claimed in claim 31, further comprising activating the complete functionality of the first cell, by the at least one first node.

33. The method as claimed in claim 31, wherein the reception of trigger signal is done by one of a low complex wake-up receiver of the at least one first node, monitoring a set of resources by the at least one first node, and a dedicated sensor at the at least one first node.

34. The method as claimed in claim 31, wherein the transmission is performed through at least one of the first cell, at least one second cell, broadcast and the at least one third node.

35. The method as claimed in claim 12, further comprising skipping the transmissions of at least one of SSB, data channel, control channel, and Reference Signal (RS).

36. The method as claimed in claim 12, further comprises:
receiving, by the at least one second node, the relaxed signal,
determining, by the at least one second node, at least one parameter related to at least one first cell using relaxed signal; and
transmitting, by the at least one second node, a trigger signal.

37. The method as claimed in claim 36, wherein the at least one parameter comprises at least one of a signal quality, an identity of the at least one first cell, and an information to perform at least one of UL synchronization and transmit RACH.

38. The method as claimed in claim 37, wherein the signal quality comprises at least one of Reference Signal Received Power (RSRP), Reference Signal Strength Indicator (RSSI), Reference Signal Received Quality (RSRQ), and Signal to Noise plus Interference ratio (SINR).

39. The method as claimed in claim 36, wherein the trigger signal comprises at least one of a measurement report, RACH signal, a low complexity wake up signal, an indication, a predefined sequence, an RS, and the identity of the at least one first cell.

40. The method as claimed in claim 36, wherein the transmission of the trigger signal is performed through broadcasting or transmitting to the at least one first node.

41. The method as claimed in claim 36, wherein the transmission of the trigger signal is performed using a resource that is one of:
predefined in standards,
obtained from the relaxed signal,
configured by at least one first node, or
preconfigured by at least one third node.

42. The method as claimed in claim 41, wherein configuration by at least one first node is performed through the at least one second cell.

43. The method as claimed in claim 40, wherein the transmission of trigger signal to at least one first node occurs through one of at least one third node, the network, the first cell, and the at least one second cell.

44. The method as claimed in claim 36, wherein the transmission of trigger signal is performed when the parameter is above a threshold, and wherein the threshold is:
predefined in standards,
determined by the at least one second node,
configured to at least one second node, or
transmitted within relaxed signal.

45. The method as claimed in claim 44, wherein configuration to the at least one second node with the threshold is done by one of at least one first node, at least one third node, and at least one second cell.

46. The method as claimed in claim 44, wherein the threshold is determined based on noise floor.

47. A method of energy saving in a cellular network, the method comprising:
determining, at least one information related to one or more of at least one first node and a network;
determining, by the at least one first node, at least one spatial element from the plurality of spatial elements, needed for communicating with at least one second node based on the at least one information,
determining, by the at least one first node, at least one parameter related to the at least one spatial element,
indicating, to the at least one second node, the at least one parameter related to the at least one spatial element; and
performing, by the at least one first node, at least one of transmission and reception using the at least one spatial element.

48. The method as claimed in claim 47, wherein the at least one first node comprises one or more of at least one Base Station (BS), at least one Integrated Access and Backhaul (IAB) node, at least one relay and at least one Distributed Unit (DU).

49. The method as claimed in claim 47, wherein the at least one second node comprises one or more of at least one User Equipment (UE), at least one IAB node, at least one Distributed Unit (DU), at least one Mobile Termination (MT) unit, at least one relay and at least one BS.

50. The method as claimed in claim 47, wherein the at least one information comprises one or more of load, traffic conditions in the network, channel conditions between the at least one first node and the at least one second node, number of second nodes connected to the at least one first node, location of the at least one second node, deployment scenario, UE arrival rate, and types of the at least one UE.

51. The method as claimed in claim 47, wherein the at least one parameter is indicated to the at least one second node using at least one of Downlink Control Information (DCI), Medium Access Control Element (MAC-CE), broadcast channel, and Radio Resource Control (RRC) message.

52. The method as claimed in claim 47, wherein determining the at least one spatial element from the plurality of spatial elements further comprises determining an active number of ports.

53. The method as claimed in claim 52, wherein the active number of ports is one of:
a difference between total number of ports and number of ports to be deactivated by the at least one first node,
a difference between total number of ports and number of ports deactivated by the at least one first node,
dependent on the spatial elements to be deactivated, or
dependent on the deactivated spatial elements.

54. The method as claimed in claim 47, wherein the performing comprises one of:
deactivation of at least one spatial element from a plurality of spatial elements based on the at least one information, or
deactivation of at least one port from a plurality of ports based on the number of spatial elements.

55. The method as claimed in claim 47, wherein determining the at least one spatial element from the plurality of spatial elements, further comprises at least one of:
deactivation by the at least one first node, at least one spatial element from a plurality of spatial elements based on the at least one information, or
deactivation by the at least one first node, at least one port from a plurality of ports based on the number of spatial elements.

56. The method as claimed in claim 47, wherein the at least one parameter includes at least one of active number of ports, indices of active number of ports, maximum number of ports active at a time, index of maximum number of ports active at a time, and variation in number of ports.

57. The method as claimed in claim 47, further comprising:
receiving, by the at least one second node, the at least one parameter from the at least one first node; and
determining, by the at least one second node, the active number of ports.

58. The method as claimed in claim 47, further comprising:
determining, by the at least one second node, at least one Channel State Information-Reference Signal (CSI-RS) resource corresponding to the active number of ports;
monitoring, by the at least one second node, the at least one CSI-RS resource, and
measuring, by the at least one second node, the at least one CSI-RS resource.

59. The method as claimed in claim 58, wherein the active number of ports is less than the maximum number of ports active at a time.

60. The method as claimed in claim 47, wherein the at least one parameter is represented using ceil {Log₂(M)} bits, and wherein M is total number of options for number of ports.

61. The method as claimed in claim 47, wherein a time offset between a time resource of reception of the at least one parameter, and a time resource of at least one of transmission and reception is indicated along with the at least one parameter.

62. The method as claimed in claim 47, the time offset between indicating the at least one parameter, and performing the at least one of transmission and reception is predefined in the standards.

63. The method as claimed in claim 47, wherein the at least one parameter is valid until one of:
expiry of a time period indicated along with the parameter,
a new indication about the at least one parameter is received from the at least one first node, or
a deactivation command is received from the at least one first node.

64. The method as claimed in claim 47, wherein the at least one parameter comprises at least one CSI-RS resource from the plurality of CSI-RS resources, and wherein the at least one CSI-RS resource is transmitted by the at least one first node using the number of spatial elements.

65. The method as claimed in claim 64, wherein the at least one CSI-RS resource is indicated using CSI-RS resource index.

66. The method as claimed in claim 47, wherein the at least one parameter is indicated using a bitmap.

67. The method as claimed in claim 66, wherein the bitmap indicates one of the:
at least one active port from the plurality of ports, and
at least one active CSI-RS resource from the plurality of CSI-RS resources.

68. The method as claimed in claim 67, wherein the active CSI-RS resource corresponds to the active number of ports.

69. The method as claimed in claim 66, wherein at least one bit of the bitmap is set when one of a corresponding port and a corresponding CSI-RS resource is active.

70. The method as claimed in claim 66, wherein at least one bit of the bitmap is reset when one of a corresponding port and a corresponding CSI-RS resource is inactive.

71. A method of energy saving in a cellular network, the method comprising: dynamically performing by at least one first node:
determining a transmit power of one or more of at least one Downlink (DL) signal and at least one DL channel,
signalling of at least one parameter related to the transmit power to at least one second node; and
transmission of one or more of at least one DL signal and at least one DL channel with the transmit power.

72. The method as claimed in claim 71, wherein the transmit power is determined based on one or more of interference strength, location of at least one second node, deployment scenario, types of the at least one User Equipment (UE) and channel condition between the at least one first node, and at least one second node.

73. The method as claimed in claim 71, wherein the at least one parameter is one or more of a multiplication factor and a type of power offset.

74. The method as claimed in claim 73, wherein the multiplication factor is applied to the power offset and wherein the power offset is determined by the type of power offset.

75. The method as claimed in claim 73, wherein the type of power offset is one of:
a ratio of power per Resource Element (RE) between Channel State Information-Reference Signal (CSI-RS) and Physical Downlink Shared Channel (PDSCH),
a ratio of power per RE between CSI-RS and Synchronization Signal Block (SSB), or
a ratio of power per RE between Demodulation Reference Signal (DM-RS) and PDSCH.

76. The method as claimed in claim 71, wherein the at least one parameter is the value of the power offset.

77. The method as claimed in claim 76, wherein the power offset is a ratio of power per RE between one or more of the at least one downlink signal and at least one DL channel.

78. The method as claimed in claim 73, wherein a value of the multiplication factor is determined based on a variation in the transmit power of one or more of at least one DL signal and at least one DL channel.

79. The method as claimed in claim 73, wherein the value of the multiplication factor is a value ranging from 0 to 1.

80. The method as claimed in claim 71, wherein the signalling is performed using at least one of control channel, broadcast channel, and Medium Access Control Element (MAC-CE).

81. The method as claimed in claim 71, wherein the transmit power of one or more of at least one DL signal and at least one DL channel is multiplied with the multiplication factor for accurate measurement of downlink signals at the at least one second node.

82. The method as claimed in claim 71, wherein the downlink signal comprises one of Primary Synchronization Signal (PSS), Secondary Synchronization Signal (SSS), DMRS, SSB, and CSI-RS.

83. The method as claimed in claim 71, wherein the downlink channel is one of Physical Broadcast Channel (PBCH), PDSCH, and Physical Downlink Control Channel (PDCCH).

84. The method as claimed in claim 71, wherein the at least one first node comprises one or more of at least one Base Station (BS), at least one Integrated Access and Backhaul (IAB) node, at least one relay, and at least one Distributed Unit (DU).

85. The method as claimed in claim 71, wherein the at least one second node comprises one or more of at least one UE, at least one IAB node, at least one DU, at least one Mobile Termination (MT) unit, at least one relay and at least one BS.

86. A method of energy saving in a cellular network, the method comprising:
determining, at least one information related to one or more of at least one first node and a network;
determining, by the at least one first node, based on the at least one information one or more of:
at least one operation to be deactivated, and
at least one parameter related to the deactivation of the at least one operation;
signalling, by the at least one first node to at least one second node, the at least one parameter related to the deactivation of the at least one operation, and
deactivating, by the at least one first node, the at least one operation.

87. The method as claimed in claim 86, wherein the at least one first node comprises one or more of at least one Base Station (BS), at least one Integrated Access and Backhaul (IAB) node, at least one relay, and at least one Distributed Unit (DU).

88. The method as claimed in claim 86, wherein the at least one second node comprises one or more of at least one User Equipment (UE), at least one IAB node, at least one DU, at least one Mobile Termination (MT) unit, at least one relay, and at least one BS.

89. The method as claimed in claim 86, wherein the at least one information is one or more of channel conditions, UE arrival rate, deployment scenario, number of connected UEs, traffic and load on the at least one first node.

90. The method as claimed in claim 86, wherein the at least one parameter includes one or more of the at least one operation, starting time of the deactivation, duration of the deactivation, type of deactivation, a priority rule, indication for re-assignment of time resource associated with deactivation, and beam ID (SSB index).

91. The method as claimed in claim 90, wherein the at least one of the starting time of the deactivation, duration of the deactivation, and indication for re-assignment of time resource associated with deactivation is indicated in terms of multiple of at least one of symbols, slots, sub-frames and frames.

92. The method as claimed in claim 91, wherein the multiple of at least one of the symbols, slots, sub-frames, and frames is indicated as at least one of a time index and a number.

93. The method as claimed in claim 90, wherein the at least one of the starting time of the deactivation and the duration of the deactivation is one of:
a dynamic value,
one or more preconfigured value, or
a value chosen from a set of predefined values.

94. The method as claimed in claim 90, wherein the type of deactivation is predefined.

95. The method as claimed in claim 90, wherein the type of deactivation comprises at least one of:
duration of deactivation,
one or more of at least one operation, signals and components deactivated, and
the priority rule.

96. The method as claimed in claim 95, wherein the signals comprise at least one of SSB, RACH, control channel, data channel, and RS.

97. The method as claimed in claim 90, wherein the indication for re-assignment is meant for informing to at least one second node to re-assign the time resource and performing the at least one operation based on the reassigned time resource.

98. The method as claimed in claim 90, wherein the priority rule comprises performing one or more of transmission and reception of at least one signal in a resource overlapping with duration of deactivation.

99. The method as claimed in claim 98, wherein the at least one signal comprises one or more of PSS, SSS and PBCH.

100. The method as claimed in claim 90, wherein the at least one first node reschedules the one or more at least one operation in a first available active time resource after the duration of the deactivation.

101. The method as claimed in claim 86, wherein the signalling comprises re-assigning by the at least one first node one or more time resource associated with the deactivation.

102. The method as claimed in claim 101, wherein the at least one first node performs the one or more operation based on the reassigned time resource.

103. The method as claimed in claim 86, wherein the at least one operation comprises one or more of:
transmission of one or more of SSB, control channel, data channel, and RS, and
reception of one or more of RACH, control channel, data channel and RS.

104. The method as claimed in claim 86, wherein one or more of signalling and deactivation is either semi-static or dynamic.

105. The method as claimed in claim 86, wherein the signalling is in at least one of Downlink Control Information (DCI), broadcast channel, Medium Access Control Element (MAC-CE), and Radio Resource Control (RRC) message.

106. The method as claimed in claim 86, wherein the deactivation is applicable for one or more of at least one cell, at least one beam, at least one carrier, and at least one sector.

107. The method as claimed in claim 86, further comprises:
receiving, by the at least one second node, the at least one parameter related to deactivation, and
performing, by at least one second node, the at least one operation based on the at least one parameter related to deactivation of the at least one operation.

108. The method as claimed in claim 107, wherein the performing the at least one operation comprises one or more of:
skipping the at least one operation, and
re-assigning the time resource for performing the at least one operation based on the reassigned time resource.

109. The method as claimed in claim 86, further comprises reactivation of the at least one operation upon reception of a trigger signal by the at least one first node.

110. The method as claimed in claim 109, wherein the trigger signal is either broadcasted or transmitted to the at least one first node.

111. The method as claimed in claim 109, wherein the at least one first node receives the trigger signal from one or more of at least one third node and the network.

112. The method as claimed in claim 111, wherein the at least one third node comprises one or more of at least one UE, at least one active BS, at least one IAB node, at least one DU, and at least one relay.

113. The method as claimed in claim 112, wherein the UE is one of a connected UE, a non-connected UE, an inactive UE, and a new UE searching for a new BS.

114. The method as claimed in claim 109, wherein the at least one first node receives the trigger signal using:
a set of resources, wherein the set of resources are one of predefined in standards and configured to the at least one third node, or
a dedicated receiver to receive the trigger signal.

115. The method as claimed in claim 114, wherein the set of resources comprises at least one of time resources, frequency resources, spatial resources, periodicity, and validity of the resources.

116. The method as claimed in claim 115, wherein the spatial resources comprises at least one of SSB index, beam index, beam pair index, reference signal index (RS-ID).

117. The method as claimed in 115, wherein the periodicity comprises an ON cycle in which the at least one first node will switch ON for a predefined time duration at intervals to monitor the trigger signal.

118. The method as claimed in claim 114, wherein the set of resources are configured to the at least one third node by one of the at least one first node, the at least one second node or the network, and wherein the at least one first node informs one of at least one second or network about the configured set of resources.

119. The method as claimed in claim 111, wherein the at least one third node transmits the trigger based on at least one of:
measurement of a signal transmitted by the at least one first node,
signal quality of at least one UE connected to the third node, and
assistance information from the at least one UE connected to the third node.

120. The method as claimed in claim 119, wherein the assistance information is at one or more of signal quality, location and direction of movement of the at least one UE.

121. The method as claimed in claim 111, wherein the at least one third node is time synchronized with the at least one first node.

122. The method as claimed in claim 111, wherein one or more of the at least one third node and the network transmits the trigger to a plurality of first nodes.

123. The method as claimed in claim 109, wherein the trigger signal is one of a measurement report of a DL signal received from the first node, a signal representing presence of a new UE upon switching ON, an indication signal, a predefined sequence, and a Sounding Reference Signal (SRS).

124. The method as claimed in claim 123, wherein the measurement report comprises one or more of quality of the received DL signal, Identity (ID) of the received DL signal, sequence of the received DL signal, and a parameter received in the DL signal.

125. The method as claimed in claim 109, further comprises deactivation of the at least one operation when no communication is established with at least one node within a duration of time after the reception of the trigger by the at least one first node.

126. The method as claimed in claim 86, further comprises updating the size of a Hybrid Automatic Repeat reQuest (HARQ) codebook based on the at least one parameter related to deactivation, by the at least one second node.

127. The method as claimed in claim 126, wherein the updating comprises:
determining whether the at least one operation comprises transmission of data signals by the at least one first node,
determining at least one candidate slot corresponding to HARQ codebook overlapping with the duration of deactivation; and
skipping feedback for at least one candidate slot in the HARQ codebook.

128. The method as claimed in claim 86, further comprises deriving by the at least one second node, an Indication of Availability (IA) for at least one soft resource based on the at least one parameter related to deactivation.

129. The method as claimed in claim 128, wherein deriving the IA comprises:
determining, whether the at least one operation comprises one of transmission or reception,
determining, the at least one soft resource overlapping with the duration of deactivation, and
deriving, IA for the at least one soft resource.

130. The method as claimed in claim 86, wherein signalling comprises one or more of:
shifting a transmission of Synchronization Signal Block (SSB) to the other half frame,
updating a one bit parameter half frame bit in a Physical Broadcast Channel (PBCH),
informing the at least one second node about the shifting operation;
shifting a transmission of SSB to a first active time resource after the duration of the deactivation, and
informing the at least one second node about the shifting operation.

131. The method as claimed in claim 130, wherein shifting the transmission of SSB to the other half frame is performed when the duration of the deactivation of operations is less than half frame size.

132. The method as claimed in claim 130, wherein the transmission of SSB overlaps with duration of deactivation.
